(19) United States
(12) Patent Application Publication
(10) Pub. No.: US 2022/0357463 A1
(43) Pub. Date: Nov. 10, 2022

(54) DELIVERY DETECTION-BASED POSITIONING INFORMATION EXTRACTION

(71) Applicant: HERE Global B.V., Eindhoven (NL)

(72) Inventors: Henri Jaakko Julius Nurminen, Tampere (FI); Pavel Ivanov, Tampere (FI); Marko Luomi, Lempaeaelae (FI)

(21) Appl. No.: 17/302,555

(22) Filed: May 6, 2021

(51) Int. Cl. G01S 19/46; G01S 19/47; G06Q 10/08; H04W 64/00

(52) U.S. Cl. CPC G01S 19/46; G01S 19/47; G06Q 10/0833; H04W 64/006

(57) ABSTRACT

The disclosure provides methods, apparatus, and products for updating a positioning map and a position estimate based on the detection of delivery events. An example method comprises obtaining a delivery address corresponding to a delivery to be made by an entity associated with a mobile device; obtaining sensor data captured by the mobile device; based on processing the sensor data, determining occurrence of one or more events indicating a moment in time that the delivery took place at the delivery address; obtaining (a) a position estimate for the mobile device substantially corresponding to the moment the delivery occurred and/or (b) delivery moment data captured by one or more sensors of the mobile device substantially at the moment the delivery took place; and updating a positioning map and/or the position estimate for the mobile device.

### TECHNOLOGICAL FIELD

Example embodiments of the present disclosure relate generally to the field of positioning technologies. In particular, example embodiments generally relate to updating, improving, and/or providing a positioning map and/or a position estimate based on the detection of delivery events.

### BACKGROUND

In various scenarios, positioning estimates are provided by positioning technologies that use cellular and/or radio frequency signal-based technologies. Such positioning technologies are based on large global and/or local databases that contain information on radio nodes and/or access points that generate and/or broadcast cellular and non-cellular radio frequency signals. However, in certain areas, positioning estimates may be unreliable, due in part to a lack of information for such areas in the large global and/or local databases. These areas include indoor locations where devices receive cellular signals with lower signal intensity, and areas where global navigation satellite system (GNSS)-based positioning is unreliable or unavailable.

Positioning estimates are commonly used in navigational applications where navigation to a specific destination address is provided. Destination addresses may be defined with high spatial resolution; for example, a specific room, office suite, or building block may be a destination address. Additionally, the destination address may be on a specific floor of a multi-floor building. The resolution and accuracy of positioning estimates affects the accuracy, precision, and usability of the navigation assistance and/or route guidance that the navigational applications are able to provide.

### BRIEF SUMMARY

One method for generating databases used by positioning technologies involves collecting information obtained and/or captured via multiple users in a crowd-sourcing paradigm. Multiple users of a positioning technology provide data in the form of a fingerprint, which primarily contains a location reference and environmental measurements. These environmental measurements may be obtained from various modalities and/or types of radio frequency signals (e.g., cellular signals, Wi-Fi, Bluetooth, Bluetooth Low Energy, and/or ultra-wideband signals). For instance, environmental measurements obtained from cellular signals may include global and/or local identifiers of cellular network cells observed, signal strength and/or pathloss estimates, and timing values such as timing advance or round-trip time. Similarly, environmental measurements obtained from Wi-Fi signals may include identifiers (e.g., media access control (MAC) address, service set identifiers (SSIDs)) of wireless local area network (WLAN) access points observed, signal strength and/or pathloss estimates, and timing values. Using fingerprints obtained from multiple users, positioning technologies generate models which include coverage areas, node positions, radio propagation models, transmitting/receiving (Tx/Rx) fields, and/or the like, that may be used to determine and provide a positioning estimate relative to and/or based on an observed environment. However, the generated models may be incomplete and/or inaccurate when positioning technologies receive and process a relatively low number of fingerprints in a geographical area, thereby possibly resulting in inaccurate and/or poor resolution positioning estimates within the geographical area.

The present disclosure provides methods, systems, and computer program products as a technical solution, which is globally scalable, requires low maintenance, and improves positioning estimates and positioning databases. Embodiments of the present disclosure leverage existing infrastructure, such as Wi-Fi networks in a building, as well as existing capabilities of user devices, to improve positioning estimates and positioning databases. In various example embodiments, delivery entities (e.g., parcel delivery couriers) are used to collect environmental measurements to provide crowd-sourced data to positioning databases. The environmental measurements may further be combined with delivery information, such as a delivery address. This combined information can be used to both improve a positioning database and/or individual positioning estimates. Various embodiments of the present disclosure are cloud-based systems, and delivery entities may transmit data such that the cloud-based systems receive data from the delivery entities.

A positioning map can be updated with sensor data collected by a mobile device associated with a delivery person, in various embodiments. Sensor data collected by the mobile device can include movement data, GNSS data, and/or signal environment data and therefore can be used to generate a position estimate for the mobile device, be used to describe the signal environment at the position of the mobile device, and be used to determine whether a delivery has happened. For example, movement data indicating that the mobile device has been stationary for a time period may suggest that the delivery person is making a delivery at the delivery address. Thus, using the sensor data to determine a moment in time that a delivery occurred, the positioning map, and specifically map data associated with the delivery address, can be updated with a position estimate for the mobile device at the delivery moment and/or with sensor data describing the signal environment observed by the mobile device when the mobile device was at the delivery address. The position estimate for the mobile device can likewise be updated based on information known about the delivery address. Using the sensor data to determine a moment in time that a delivery occurred, the position estimate for the mobile device can be updated based on the understanding that the mobile device is located at the delivery address at the moment in time when the delivery occurs.

In an example embodiment, a processor obtains a delivery address corresponding to a delivery to be made by an entity associated with a mobile device. The processor then obtains sensor data captured by the mobile device. The processor determines occurrence of one or more events indicating a moment in time that the delivery took place at the delivery address based on processing the sensor data captured by the mobile device. The processor then obtains at least one of (a) a position estimate for the mobile device substantially corresponding to the moment the delivery occurred, or (b) delivery moment data captured by one or more sensors of the mobile device substantially at the moment the delivery took place. The processor then updates at least one of a positioning map or the position estimate for the mobile device based on the delivery address and the at least one of (a) the position estimate or (b) the delivery moment data.

In an example embodiment, a computing device obtains a delivery address corresponding to a delivery to be made by an entity associated with a mobile device. The computing device then obtains sensor data captured by the mobile device. The computing device determines occurrence of one or more events indicating a moment in time that the delivery took place at the delivery address based on processing the sensor data captured by the mobile device. The computing device then obtains at least one of (a) a position estimate for the mobile device substantially corresponding to the moment the delivery occurred, or (b) delivery moment data captured by one or more sensors of the mobile device substantially at the moment the delivery took place. The computing device then updates at least one of a positioning map or the position estimate for the mobile device based on the delivery address and the at least one of (a) the position estimate or (b) the delivery moment data. In an embodiment, the computing device is the mobile device. In another embodiment, the computing device is a system device separate from the mobile device.

In accordance with an aspect of the present disclosure, a method is provided. The method includes obtaining, by at least one processor, a delivery address corresponding to a delivery to be made by an entity associated with a mobile device; obtaining, by the at least one processor, sensor data captured by the mobile device; determining, by the at least one processor, occurrence of one or more events indicating a moment in time that the delivery took place at the delivery address based on processing the sensor data; obtaining, by the at least one processor, at least one of (a) a position estimate for the mobile device substantially corresponding to the moment the delivery occurred, or (b) delivery moment data captured by one or more sensors of the mobile device substantially at the moment the delivery took place; and updating, by the at least one processor, at least one of a positioning map or the position estimate for the mobile device based on the delivery address and the at least one of (a) the position estimate or (b) the delivery moment data.

In an example embodiment, updating the positioning map includes associating the delivery moment data with the delivery address in map data of the positioning map. In an example embodiment, associating the delivery moment data with the delivery address includes assigning the delivery moment data with an area corresponding to at least one of (a) the delivery address, or (b) an uncertainty associated with the position estimate. In an example embodiment, the delivery moment data includes radio data identifying at least one radio device observed by the mobile device substantially at the moment the delivery took place. In an example embodiment, updating the positioning map includes associating the position estimate with the delivery address, wherein the position estimate is determined based at least in part on the sensor data captured by the mobile device. In an example embodiment, updating the position estimate includes providing the delivery address to a positioning filter or smoother algorithm as a measurement associated with an uncertainty that substantially covers an area associated with the delivery address.

In an example embodiment, the one or more events include at least one of (i) receipt of an indication of user input received via a user interface of the mobile device, the user input indicating that the delivery occurred, (ii) receipt of an indication of a recipient signature via the user interface of the mobile device, (iii) based on the sensor data, a determination that the mobile device was stationary for at least a threshold amount of time, (iv) based on the sensor data, a determination that a heading of the mobile device changed by substantially 180 degrees, (v) based on the sensor data, a determination of a retracing of a trajectory from a building entry point to a delivery point by the mobile device, (vi) identification of a furthermost point from the building entry point for a trajectory of the mobile device in a building corresponding to the building entry point, (vii) determination by a machine-learning trained classification algorithm that the delivery occurred, or (viii) determination that the mobile device is located on a floor of the delivery address based at least in part on barometer data captured by the mobile device, the floor being a level of a building associated with the delivery address that does not include the building entry point.

In an example embodiment, indication of the user input or the indication of the recipient signature is provided by a courier application operating on the mobile device. In an example embodiment, the sensor data includes at least one of (a) movement data captured by the one or more inertial and/or motion sensors of the mobile device, (b) radio data captured by one or more radio sensors of the mobile device, or (c) barometer data captured by a barometer of the mobile device. In an example embodiment, the delivery address is obtained from a courier application operating on the mobile device.

In an example embodiment, the position estimate is determined based at least in part on a GNSS-based position estimate of the mobile device prior to the mobile device entering a building associated with the delivery address via a building entry point. In an example embodiment, the position estimate is further determined based at least in part on (a) a GNSS-based position of the mobile device after the mobile device exits the building, or (b) a trajectory of the mobile device through the building determined based at least in part on the sensor data.

According to another aspect of the present disclosure, an apparatus comprising at least one processor and at least one non-transitory memory including computer program code is provided. The at least one memory and the computer program code are configured to, with the at least one processor, cause an apparatus to obtain a delivery address corresponding to a delivery to be made by an entity associated with a mobile device; obtain sensor data captured by the mobile device; determine occurrence of one or more events indicating a moment in time that the delivery took place at the delivery address based on processing the sensor data; obtain at least one of (a) a position estimate for the mobile device substantially corresponding to the moment the delivery occurred, or (b) delivery moment data captured by one or more sensors of the mobile device substantially at the moment the delivery took place; and update at least one of a positioning map or the position estimate for the mobile device based on the delivery address and the at least one of (a) the position estimate or (b) the delivery moment data.

In an example embodiment, updating the positioning map includes associating the delivery moment data with the delivery address in map data of the positioning map. In an example embodiment, associating the delivery moment data with the delivery address includes assigning the delivery moment data with an area corresponding to at least one of (a) the delivery address, or (b) an uncertainty associated with the position estimate. In an example embodiment, the delivery moment data includes radio data identifying at least one radio device observed by the mobile device substantially at the moment the delivery took place. In an example embodiment, updating the positioning map includes associating the position estimate with the delivery address, wherein the position estimate is determined based at least in part on the sensor data captured by the mobile device. In an example embodiment, updating the position estimate includes providing the delivery address to a positioning filter or smoother algorithm as a measurement associated with an uncertainty that substantially covers an area associated with the delivery address.

In an example embodiment, the one or more events include at least one of (i) receipt of an indication of user input received via a user interface of the mobile device, the user input indicating that the delivery occurred, (ii) receipt of an indication of a recipient signature via the user interface of the mobile device, (iii) based on the sensor data, a determination that the mobile device was stationary for at least a threshold amount of time, (iv) based on the sensor data, a determination that a heading of the mobile device changed by substantially 180 degrees, (v) based on the sensor data, a determination of a retracing of a trajectory from a building entry point to a delivery point by the mobile device, (vi) identification of a furthermost point from the building entry point for a trajectory of the mobile device in a building corresponding to the building entry point, (vii) determination by a machine-learning trained classification algorithm that the delivery occurred, or (viii) determination that the mobile device is located on a floor of the delivery address based at least in part on barometer data captured by the mobile device, the floor being a level of a building associated with the delivery address that does not include the building entry point.

In an example embodiment, indication of the user input or the indication of the recipient signature is provided by a courier application operating on the mobile device. In an example embodiment, the sensor data includes at least one of (a) movement data captured by the one or more inertial and/or motion sensors of the mobile device, (b) radio data captured by one or more radio sensors of the mobile device, or (c) barometer data captured by a barometer of the mobile device. In an example embodiment, the delivery address is obtained from a courier application operating on the mobile device.

In an example embodiment, the position estimate is determined based at least in part on a GNSS-based position estimate of the mobile device prior to the mobile device entering a building associated with the delivery address via a building entry point. In an example embodiment, the position estimate is further determined based at least in part on (a) a GNSS-based position of the mobile device after the mobile device exits the building, or (b) a trajectory of the mobile device through the building determined based at least in part on the sensor data.

In accordance with another example embodiment, a computer program product is provided that comprises at least one non-transitory computer-readable storage medium having computer-executable program code instructions stored therein. The computer-executable program code instructions comprise program code instructions configured to, when executed by at least one processor, cause the at least one processor to obtain a delivery address corresponding to a delivery to be made by an entity associated with a mobile device; obtain sensor data captured by the mobile device; determine occurrence of one or more events indicating a moment in time that the delivery took place at the delivery address based on processing the sensor data; obtain at least one of (a) a position estimate for the mobile device substantially corresponding to the moment the delivery occurred, or (b) delivery moment data captured by one or more sensors of the mobile device substantially at the moment the delivery took place; and update at least one of a positioning map or the position estimate for the mobile device based on the delivery address and the at least one of (a) the position estimate or (b) the delivery moment data.

In an example embodiment, updating the positioning map includes associating the delivery moment data with the delivery address in map data of the positioning map. In an example embodiment, associating the delivery moment data with the delivery address includes assigning the delivery moment data with an area corresponding to at least one of (a) the delivery address, or (b) an uncertainty associated with the position estimate. In an example embodiment, the delivery moment data includes radio data identifying at least one radio device observed by the mobile device substantially at the moment the delivery took place. In an example embodiment, updating the positioning map includes associating the position estimate with the delivery address, wherein the position estimate is determined based at least in part on the sensor data captured by the mobile device. In an example embodiment, updating the position estimate includes providing the delivery address to a positioning filter or smoother algorithm as a measurement associated with an uncertainty that substantially covers an area associated with the delivery address.

In an example embodiment, the one or more events include at least one of (i) receipt of an indication of user input received via a user interface of the mobile device, the user input indicating that the delivery occurred, (ii) receipt of an indication of a recipient signature via the user interface of the mobile device, (iii) based on the sensor data, a determination that the mobile device was stationary for at least a threshold amount of time, (iv) based on the sensor data, a determination that a heading of the mobile device changed by substantially 180 degrees, (v) based on the sensor data, a determination of a retracing of a trajectory from a building entry point to a delivery point by the mobile device, (vi) identification of a furthermost point from the building entry point for a trajectory of the mobile device in a building corresponding to the building entry point, (vii) determination by a machine-learning trained classification algorithm that the delivery occurred, or (viii) determination that the mobile device is located on a floor of the delivery address based at least in part on barometer data captured by the mobile device, the floor being a level of a building associated with the delivery address that does not include the building entry point.

In an example embodiment, indication of the user input or the indication of the recipient signature is provided by a courier application operating on the mobile device. In an example embodiment, the sensor data includes at least one of (a) movement data captured by the one or more inertial and/or motion sensors of the mobile device, (b) radio data captured by one or more radio sensors of the mobile device, or (c) barometer data captured by a barometer of the mobile device. In an example embodiment, the delivery address is obtained from a courier application operating on the mobile device.

In an example embodiment, the position estimate is determined based at least in part on a GNSS-based position estimate of the mobile device prior to the mobile device entering a building associated with the delivery address via a building entry point. In an example embodiment, the position estimate is further determined based at least in part on (a) a GNSS-based position of the mobile device after the mobile device exits the building, or (b) a trajectory of the mobile device through the building determined based at least in part on the sensor data.

In accordance with yet another aspect of the present disclosure, an apparatus is provided that comprises means for obtaining a delivery address corresponding to a delivery to be made by an entity associated with a mobile device. The apparatus comprises means for obtaining sensor data captured by the mobile device. The apparatus comprises means for determining occurrence of one or more events indicating a moment in time that the delivery took place at the delivery address based on processing the sensor data. The apparatus comprises means for obtaining at least one of (a) a position estimate for the mobile device substantially corresponding to the moment the delivery occurred, or (b) delivery moment data captured by one or more sensors of the mobile device substantially at the moment the delivery took place. The apparatus comprises means for updating at least one of a positioning map or the position estimate for the mobile device based on the delivery address and the at least one of (a) the position estimate or (b) the delivery moment data.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of a system apparatus that may be specifically configured in accordance with an example embodiment;

FIG. 2B is a block diagram of a user apparatus that may be specifically configured in accordance with an example embodiment;

FIG. 3A is a diagram of an example environment within which example methods, operations, functions, and/or the like, may be performed, in accordance with an example embodiment;

FIG. 3B is a diagram of an example environment within which example methods, operations, functions, and/or the like, may be performed, in accordance with an example embodiment;

FIG. 3C is a diagram of an example environment within which example methods, operations, functions, and/or the like, may be performed, in accordance with an example embodiment; and

FIG. 4 is a flowchart providing an example process for determining a delivery moment and updating positioning information, in accordance with an example embodiment.

### DETAILED DESCRIPTION

Some embodiments will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

### I. GENERAL OVERVIEW

Various embodiments provide methods, apparatuses, and products for updating a positioning map and/or a position estimate of a mobile device based on the detection of delivery actions/events indicating items being delivered at known respective delivery addresses. The detection of delivery actions/events is based on sensor data captured by the mobile device. Sensor data captured by the mobile device comprises movement data, GNSS data, signal environment data, and/or the like and therefore can be used to generate a position estimate for the mobile device, be used to describe the signal environment at the position of the mobile device, and/or be used to determine whether a delivery has occurred at a respective delivery address. For example, movement data indicating that the mobile device has been stationary for a time period suggests that the delivery person is making a delivery at the respective delivery address. Sensor data may also describe other actions or events that indicate that the delivery person made a delivery at the delivery address as well as the moment in time that the delivery occurred. Thus, using the sensor data to determine a moment in time that a delivery occurred, the positioning map (e.g., map data associated with the delivery address) can be updated with a position estimate for the mobile device at the delivery moment and/or sensor data describing the signal environment observed by the mobile device at the delivery moment. The position estimate for the mobile device can likewise be updated. For example, using the sensor data to determine a moment in time that a delivery occurred, the position estimate for the mobile device can be updated based on the understanding that the mobile device is located at the delivery address at the moment in time the delivery occurred.

As such, various embodiments provide technical solutions, improvements, and advantages to various existing technical problems. Using various methods, systems, apparatuses, and/or products described herein, a positioning map or positioning database may be updated and supplemented with a large amount of information, especially when the positioning map or positioning database is in communication with multiple mobile devices associated with multiple delivery entities, or at least when the positioning map or positioning database receives data captured by multiple mobile devices. Moreover, a position estimate of a mobile device associated with a delivery entity may be improved by using the delivery address as a reference position of the mobile device at the moment in time when the delivery occurred. Thus, it may be recognized that various embodiments of the present disclosure may be implemented to update a positioning map or database in a crowd-sourcing manner and/or to improve sensor fusion, motion, and/or inertial measurement unit (IMU)-based position estimates.

### II. EXEMPLARY SYSTEM

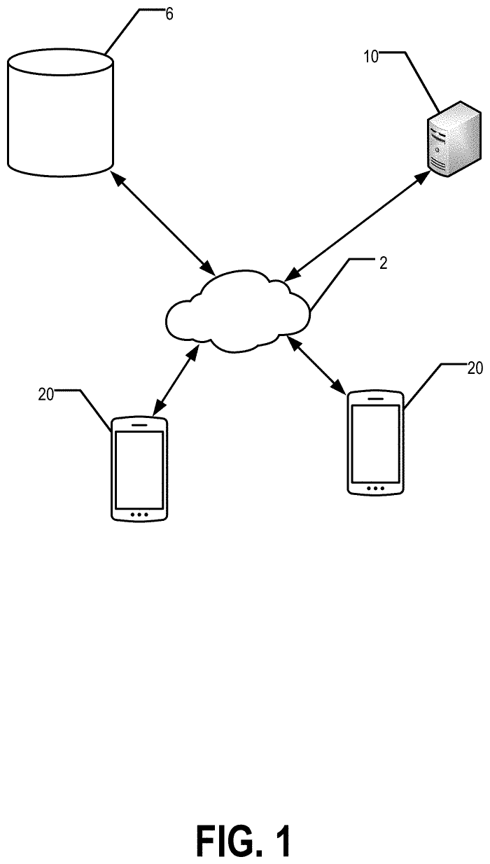

FIG. 1 provides an illustration of an example system that can be used in conjunction with various embodiments of the present disclosure. As shown in FIG. 1, the system may include a system apparatus 10 and one or more user apparatuses 20. In various example embodiments, the system apparatus 10 is a cloud-based computing system comprising one or more computing apparatuses each comprising at least one processor. The system further includes a database 6. The database 6 may be a positioning database and may store positioning models, positioning maps, crowd-sourced positioning estimates, sensor data received from one or more user apparatuses 20, and/or the like. System apparatus 10, one or more user apparatuses 20, and database 6 may be in communication with each other via a network 2. The network 2 may be a wired or a wireless network.

In various embodiments, the system apparatus 10 is configured to receive data transmitted by a user apparatus 20. The system apparatus 10 may receive a delivery address from the user apparatus 20 and may further receive sensor data captured by the user apparatus 20. For example, the user apparatus 20 comprises one or more sensors that capture sensor data, and the user apparatus 20 transmits the sensor data such that the system apparatus 10 receives the sensor data. The system apparatus 10 may be configured to receive sensor data from a user apparatus 20 continuously, at a specific frequency, and/or on an ad hoc basis.

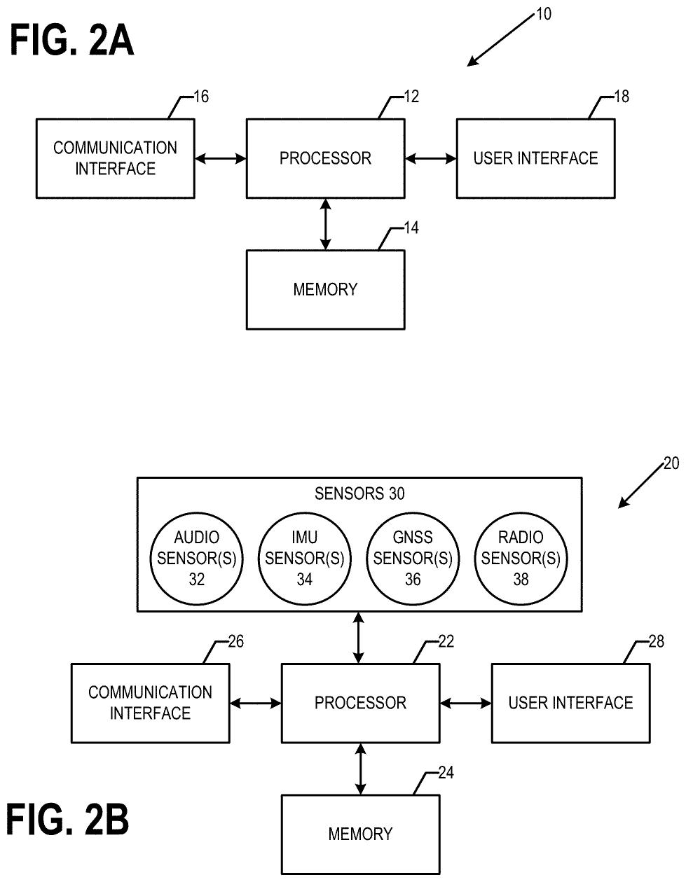

As shown in FIG. 2A, the system apparatus 10 may comprise a processor 12, memory 14, a communication interface 16, a user interface 18, and/or other components configured to perform various operations, procedures, functions, or the like described herein. In various embodiments, the system apparatus 10 stores (e.g., in memory 14) computer program code and/or instructions for determining the occurrence of a delivery event based on received sensor data. In an example embodiment, the system apparatus 10 stores at least a portion of one or more digital positioning maps in memory 14. In at least some example embodiments, the memory 14 is non-transitory. The system apparatus 10 may store further computer program code and/or instructions for performing various operations, procedures, functions, or the like described herein. For example, the system apparatus 10 stores computer program code and/or instructions for updating a positioning map (e.g., a positioning map stored in memory 14, a positioning map stored in database 6), in an example embodiment.

Likewise, the system apparatus 10 may be configured to (e.g., store computer program code and/or instructions to) update a position estimate for a user apparatus 20. For example, the system apparatus 10 may update a position estimate for a user apparatus 20 based on at least a delivery address, an initial position estimate for the user apparatus 20, sensor data, and delivery moment data captured at the moment of a delivery, in an example embodiment. The system apparatus 10 may further update the position estimate for a user apparatus 20 based on a positioning map (e.g., a positioning map stored in memory 14, a positioning map stored in database 6) and/or one or more positioning models.

In various embodiments, system apparatus 10 is configured in a cloud computing architecture distributed over multiple servers. For example, network 2 may allow shared computer processing resources and data between any number of system apparatuses 10 connected thereto. In an example embodiment then, the system apparatus 10 is a cloud-based computing system.

The user apparatus 20 is a mobile computing device such as a smartphone, tablet, laptop, PDA, an Internet of Things (IoT) device, and/or the like. Each user apparatus 20 may be associated with a delivery entity, such as a parcel delivery courier. For example, a parcel delivery courier may be equipped with a user apparatus 20, such as a mobile phone, to assist in performing various delivery tasks. The user apparatus 20 may be configured such that a courier application (e.g., a software application) can execute and/or operate on the user apparatus 20. The courier application may be configured to provide a delivery address associated with a delivery to the user apparatus 20, the delivery entity, the system apparatus 10, and/or the database 6.

As shown in FIG. 2B, the user apparatus 20 may comprise a processor 22, memory 24, a communication interface 26, a user interface 28, one or more sensors 30, and/or other components configured to perform various operations, procedures, functions, or the like described herein. In an example embodiment, the user apparatus 20 stores at least a portion of one or more digital positioning maps in memory 24. In various embodiments, the user apparatus 20 stores one or more delivery addresses, sensor data, delivery moment data, timestamps, and/or the like, in memory 24. In various example embodiments, the user apparatus 20 stores computer program code and/or instructions for performing various operations, procedures, functions, or the like described herein. In at least some example embodiments, the memory 24 is non-transitory.

In various example embodiments, the sensors 30 of a user apparatus 20 comprise one or more audio sensors 32, one or more IMUS and/or motion/inertial sensors 34, one or more GNSS sensors 36, one or more radio sensors 38, and/or other sensors. In an example embodiment, the one or more audio sensors 32 comprise one or more microphones and/or other audio sensors configured to capture audio sensor data. The audio sensor data may indicate that a delivery has taken place (e.g., a conversation between the delivery entity associated with the user apparatus 20 and a recipient entity). In an example embodiment, the one or more IMU and/or motion sensors 34 comprise one or more accelerometers, barometers, gyroscopes, magnetometers, and/or the like, configured to capture inertial and/or movement data. In various example embodiments, a barometer may be a part of the one or more IMU and/or motion sensors 34. In other example embodiments, a barometer may be a separate component of the sensors 30. The inertial and/or movement data may include data indicative of a delivery taking place (e.g., data indicating that the user apparatus 20 was stationary for a pre-determined amount of time and/or the user apparatus 20 turned around and/or began retracing it's earlier trajectory). In an example embodiment, the one or more GNSS sensors 36 are configured to receive GNSS signals (e.g., from GNSS satellites) and determine GNSS-based position estimates and/or other information based on the received GNSS signals.

In various embodiments, the one or more radio sensors 38 comprise one or more radio interfaces configured to observe and/or receive signals generated and/or transmitted by one or more access points and/or other user apparatuses 20. The one or more radio sensors 38 may be configured to receive, capture, measure, and/or observe signals for various types of access points, such as cellular network access points, Wi-Fi network access points, Bluetooth network access points, and/or the like. For example, the interface of a radio sensor 38 may be configured to observe one or more types of signals generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor 38 may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) 38 may be configured to observe radio, millimeter, microwave, and/or infrared wavelength signals. The one or more radio sensors 38 may capture radio sensor data that may include identifiers (e.g., cell ID, MAC address, SSID) of observed access points, signal strength and pathloss estimates, timing measurements such as one-way or round-trip time, and/or the like. In an example embodiment, the interface of radio sensor 38 may be coupled to and/or part of a communication interface 26.

In various embodiments, the sensors 30 further comprises one or more image sensors configured to capture visual data, such as digital camera(s), 3D camera, 360° cameras, and/or image sensors. For example, one or more image sensors may capture visual data indicating that a delivery took place at the delivery address, where the visual data may include an image of an item or parcel being left on a doorstep, an image of the delivery address (e.g., reception desk, the room number), and/or the like. In various embodiments, the one or more sensors 30 may comprise various other sensors such as two-dimensional (2D) and/or three-dimensional (3D) light detection and ranging (LiDAR)(s), long, medium, and/or short range radio detection and ranging (RADAR), ultrasonic sensors, electromagnetic sensors, (near-) infrared (IR) cameras, and/or the like.

In an example embodiment, the sensor data is continuously (e.g., at a specific frequency) captured and stored, such that particular patterns and trends may be identified. For example, the sensor data may be stored in a buffer of a pre-determined size (e.g., in memory 24). For example, sensor data including inertial and/or movement data (e.g., captured and/or generated by IMU and/or motion sensors 34) may be stored such that a heading or orientation of the user apparatus 20 is captured throughout a time period and a moment in time when the heading or orientation of the user apparatus 20 changes by substantially 180 degrees (e.g., in a range of 150 to 210 degrees, for example) can be identified. As another example, sensor data including barometric data (e.g., captured by one or more IMU and/or motion sensors 34) may be stored such that a moment in time when the user apparatus 20 is at a specific elevation relative to a starting elevation can be identified. It may be understood that sensor data is continuously captured and stored (e.g., in association with a timestamp indicating the time and/or date the sensor data was captured) such that sensor data may be associated with various different moments in time, and sensor data associated with different moments in time may be compared. For example, sensor data may comprise timestamps and/or be associated with timestamps.

Returning to the system of FIG. 1, each of the components, such as a system apparatus 10, one or more user apparatuses 20, and a database 6, may be in electronic communication with, for example, one another over the same or different wireless or wired networks 2 including, for example, a wired or wireless Personal Area Network (PAN), Local Area Network (LAN), Metropolitan Area Network (MAN), Wide Area Network (WAN), cellular network, and/or the like. In an example embodiment, a network 2 comprises the automotive cloud, digital transportation infrastructure (DTI), radio data system (RDS)/high definition (HD) radio or other digital radio system, and/or the like. A user apparatus 20 may communicate with the system apparatus 10 via a network, such as the Cloud. For example, the Cloud may be a computer network that provides shared computer processing resources and data to computers and other devices connected thereto. For example, the user apparatus 20 captures sensor data and provides the sensor data such that the system apparatus 10 receives the sensor data via the network 2. For example, the system apparatus 10 may be configured to provide an updated position estimate for the user apparatus 20 via the network 2.

### III. EXEMPLARY OPERATIONS

In various embodiments, a delivery entity (e.g., courier, postal worker, delivery person, delivery robot, drone, and/or the like) has been tasked with delivering an item (e.g., an item that is or is enclosed in one or more packages, envelopes, parcels, bags, goods, products, containers, loads, crates, items banded together, vehicle parts, pallets, drums, the like, and/or similar words used herein interchangeably) to a corresponding delivery address. The delivery entity carries (e.g., on their person, in a pocket, in their hand, in an apparatus harness, as part of the delivery entity, and/or the like) a user apparatus 20. The user apparatus 20 is configured to capture sensor data (e.g., via one or more sensors 30 thereof) and provide at least a portion of the sensor data, use the sensor data to determine when the delivery of the item to the delivery address occurred (e.g., determine a delivery time), and/or the like. Based on the delivery address and at least one of a position estimate corresponding to the delivery time or delivery moment data captured by one or more sensors 30 substantially at the delivery time, a positioning database (e.g., a radio positioning map) and/or position estimate (e.g., determined using an IMU and/or motion-based positioning process) may be updated.

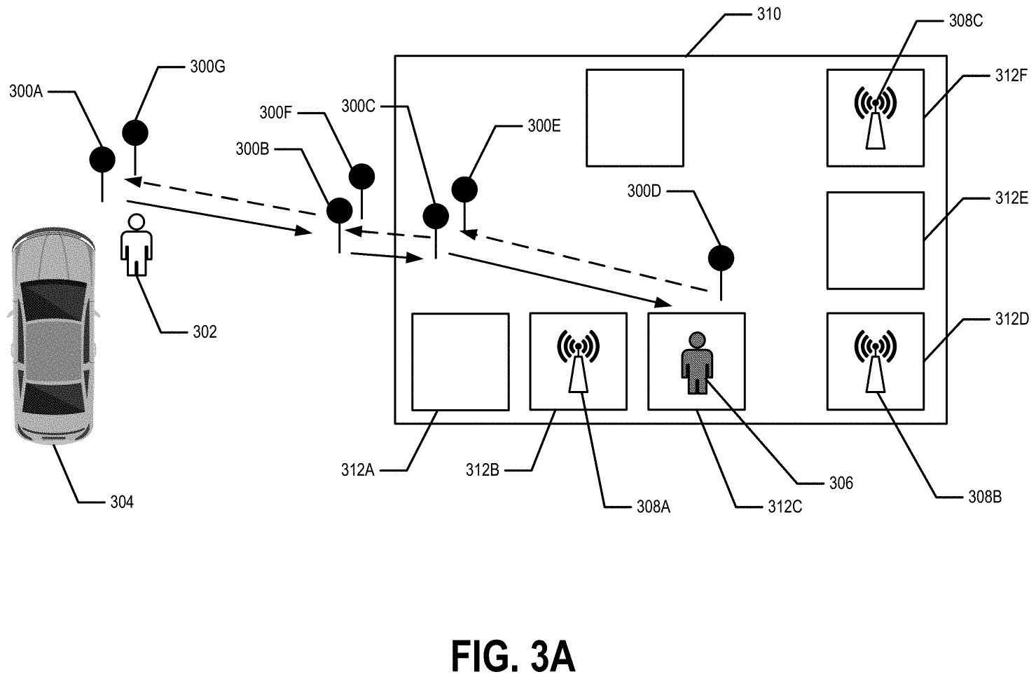

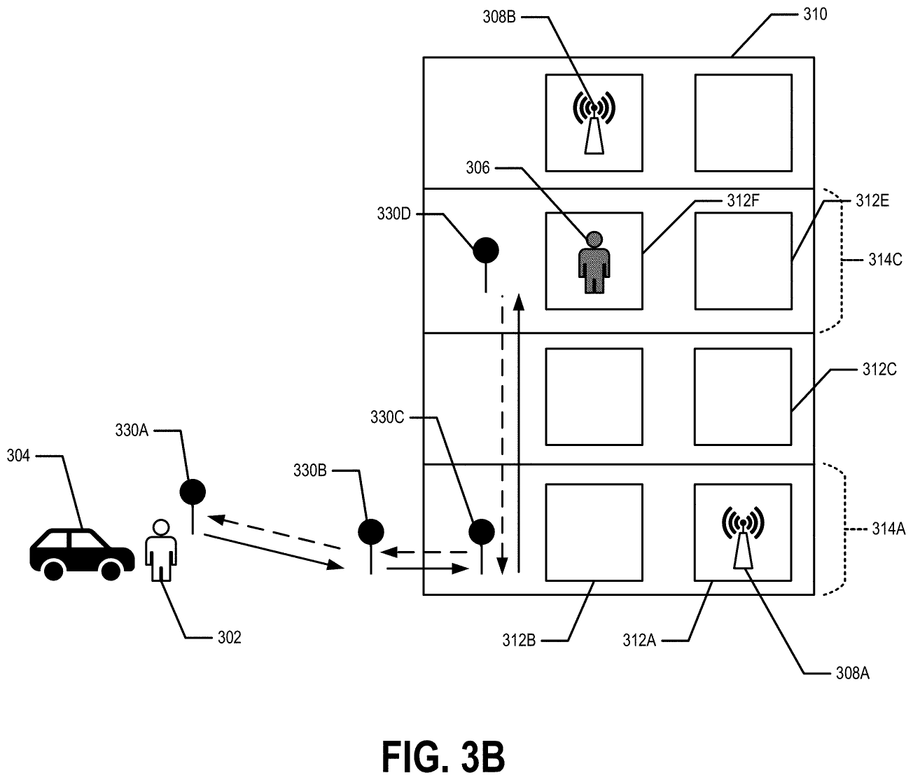

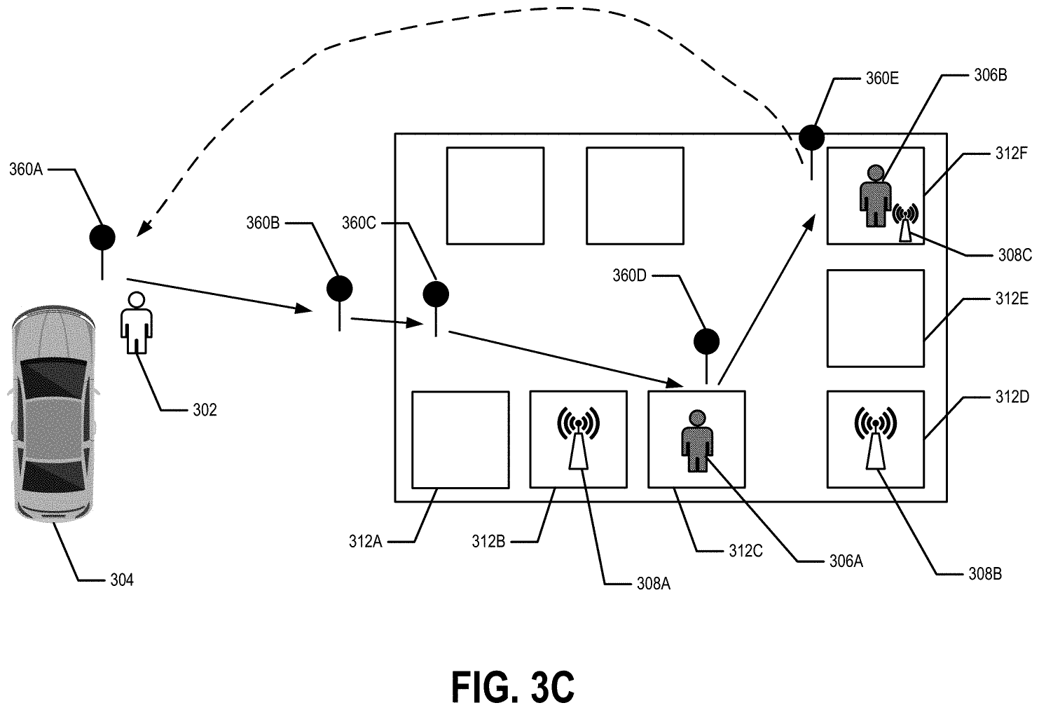

FIGS. 3A-C illustrate various environments or scenarios within which example methods, operations, functions, and/or the like, of the present disclosure may be performed. Referring first to FIG. 3A, a delivery entity 302 has been tasked with travelling to a delivery address to deliver an item. In the illustrated embodiment, the delivery entity 302 is a parcel delivery courier delivering an envelope and/or parcel to the delivery address of a receiving entity 306, with the delivery address being a room 312C in a building 310. It will be understood that the delivery entity 302 may be any entity, person, device, robotic apparatus, and/or the like, tasked with delivering the item to the delivery address. In various example embodiments, the delivery address (e.g., room 312C) may be a specific location within the building 310, and the building 310 may include multiple other similar locations (e.g., other rooms 312, retail locations, industrial locations, commercial locations, office locations, apartments) and/or other places of interest (“POI”).

The delivery entity 302 may be associated with (e.g., possess, use, operate, be co-located with) a user apparatus 20 while performing the delivery. In various embodiments, the user apparatus 20 is a mobile device. A courier application (e.g., a software application) may be operating on the user apparatus 20. The courier application may be configured to provide delivery information to the delivery entity 302. For example, the courier application may display the delivery address (e.g., room 312C) on a user interface 28 (e.g., a display) of the user apparatus 20. In an example embodiment, the courier application obtains the delivery address (e.g., room 312C) via user input through a user interface 28 of the user apparatus 20. In another example embodiment, the courier application obtains the delivery address (e.g., room 312C) from a database 6, such as a courier service database (e.g., via communication interface 26). The courier application may also be configured to communicate with a navigation application and/or a positioning engine operating on the user apparatus 20, such that the navigation application and/or the positioning engine obtains the delivery address (e.g., room 312C). In various embodiments, the courier application operating on the user apparatus 20 provides the delivery address (e.g., room 312C) such that the system apparatus 10 obtains the delivery address (e.g., room 312C).

A delivery entity 302 may first arrive, such as via a delivery vehicle 304, to the building 310 within which the delivery address (e.g., room 312C) is located. To be specific, the delivery address may be in a format that describes both a street-level address and a unit-level address, such as 1201 West Peachtree Street, Suite #4900. It may be understood then that, in this example, the unit-level address (e.g., Suite #4900, room 312C) is located within a building 310 located at the street-level address (e.g., 1201 West Peachtree Street, building 310). As such, the delivery entity 302 may first navigate (e.g., in a delivery vehicle 304) to the building 310, or a general area encompassing, including, containing, and/or the like, the delivery address.

To aid understanding of the various methods, operations, functions, and/or the like, provided and described herein, FIG. 3A illustrates various timepoints (e.g., timepoints 300A, 300B, 300C, 300D), at which various states, actions, operations, data, and/or the like of at least the delivery entity 302, user apparatus 20, and system apparatus 10 will be described. In various example embodiments, the first timepoint 300A may be any moment in time when the delivery entity 302 has exited the delivery vehicle 304 and has begun navigating (e.g., walking) to the delivery address (e.g., room 312C). The user apparatus 20 may determine, based on inertial and/or movement data captured via one or more IMU and/or motion sensors 34, that the delivery entity 302 has exited the delivery vehicle 304 and has begun walking to the delivery address. For example, one or more IMU and/or sensors 34 are, are a part of, comprise, are associated with, and/or the like, an accelerometer and/or the like configured for use as a step tracker or pedometer configured to determine when the delivery entity 302 has begun walking. In another example embodiment, the first timepoint 300A may be a moment in time when the delivery entity 302 is within a pre-determined radius of the delivery address (e.g., building 310 room 312C). For example, the user apparatus 20 may determine, based on position estimates based on GNSS data captured via one or more GNSS sensors 36, that the delivery entity 302 is within a pre-determined radius of the delivery address.

At the first timepoint 300A, the user apparatus 20 may begin capturing sensor data, where the sensor data may include audio data, inertial and/or movement data, GNSS data, radio data, and/or other data captured by one or more sensors 30 of the user apparatus 20. The sensor data may be used to generate position estimates. First, GNSS data (e.g., GNSS signals received from GNSS satellites) may be used to generate a GNSS-based position estimate. It will be understood that, due to the user apparatus 20 being positioned outside of the building 310, the user apparatus 20 may receive GNSS signals at a higher intensity and/or receive more GNSS signals, such that GNSS-based position estimates may be relatively reliable and accurate. Next, inertial and/or movement data captured by one or more IMU and/or motion sensors 34 (e.g., accelerometers, barometers, gyroscopes, magnetometers, and/or the like), may be used to supplement the GNSS-based position estimate to generate a fusion position estimate. For example, sensor data may include inertial and/or movement data indicating that the user apparatus 20 has travelled 5 meters east-bound since the last time a GNSS-based position estimate was obtained. As such, a fusion position estimate may be generated that indicates a location 5 meters east of the last GNSS-based position estimate. In various embodiments, a fusion position estimate may have a higher spatial resolution or granularity than a GNSS-based position estimate. In various embodiments, the uncertainty associated with the fusion position estimate may be generally higher than the uncertainty associated with the last GNSS-based position estimate. In various embodiments, the fusion position estimates comprise timestamps or are generally associated with moments in time.

The sensor data may also be captured in order to determine the occurrence of one or more events indicating a moment in time that a delivery took place at the delivery address. For example, inertial and/or movement data may indicate that a heading or orientation of the user apparatus 20 changed by substantially 180 degrees (e.g., within a range of 150 to 210 degrees), which may be considered to be an event indicating that a delivery took place. It may be understood that a change in heading by substantially 180 degrees refers to a 180 degree change in a substantially horizontal plane, such as the delivery entity 302 turning around by 180 degrees after making a delivery. As another example, inertial and/or movement data captured by one or more IMU and/or motion sensors 34 may indicate that the user apparatus 20 was stationary for at least a threshold amount of time, which may also be considered to be a delivery event. The user apparatus 20 being stationary may correspond to the delivery entity 302 performing the delivery at the delivery address (e.g., room 312C). Other modalities of sensor data and/or various combinations of sensor data may be used to determine the occurrence of a delivery event. For example, audio data may be used to identify a moment in time when a delivery entity 302 converses and/or interacts with a receiving entity 306, such as when the delivery entity 302 is making a delivery.

Furthermore, sensor data may be captured to obtain measurements from the environment and describe the environment from the perspective of the user apparatus 20, or the perspective at the position of the user apparatus 20. Sensor data may include radio data, captured by one or more radio sensors 38. Radio data may include identifiers for nearby and/or observed network access points 308 (e.g., 308A, 308B, 308C, which may be cellular access points, Wi-Fi access points, and/or the like), signals strengths, timing measurements for observed network access point(s), transmission channels or frequencies for observed network access point(s), and/or the like. For example, one or more network access points 308 may be located in various locations throughout the building 310, each network access point 308 transmitting and receiving network signals (e.g., cellular signals, Wi-Fi signals, Bluetooth signals and/or other radio frequency signals). It may be appreciated that, as such, radio data may be different at different positions or locations of the user apparatus 20 (e.g., as the user apparatus 20 travels through at least a portion of the building 310), and radio data may describe a unique radio environment at different moments in time. For example, at the first timepoint 300A, the user apparatus 20 may not capture radio data due to the user apparatus 20 being positioned outside of the building 310 and not observing network access points 308A-C. As another example, the user apparatus 20 may observe network access point 308A, and the captured radio data may include an identifier for network access point 308A and indicate that the signal strength for network access point 308A is relatively low.

Because radio data uniquely describes radio environments at different locations, radio data may be used to also generate fusion position estimates. That is, fusion position estimates may not be solely based on GNSS data and inertial and/or movement data. Various locations may be associated with radio data describing the radio environments at the various locations in map data of a positioning map. Thus, the user apparatus 20 may reference a positioning map to supplement a GNSS-based position estimate with radio data. For example, a positioning map comprises various models including coverage areas, access point positions, radio propagation models, and/or the like, to determine and provide a positioning estimate based on a radio environment. For example, a location 10 meters outside of the building 310 may be associated with radio data including an identifier for only network access point 308A, a specific signal strength for network access point 308A, and specific timing values for network access point 308A, in a positioning map. Thus, if the user apparatus 20 captures radio data indicating that the user apparatus 20 only observes network access point 308A and including substantially similar signal strength measurements and timing value measurements, the user apparatus 20 may generate a fusion position estimate based on the location 10 meters outside of the building 310 and the last obtained GNSS-based position estimate.

Therefore, as aforementioned, sensor data captured by the user apparatus 20 may serve at least three purposes. First, position estimates (e.g., GNSS-based position estimates, fusion position estimates) may be continuously and/or periodically generated based on sensor data for the user apparatus 20 during a delivery time period, such as a time period beginning when the delivery entity 302 exits the delivery vehicle 304 and ending when the delivery entity 302 returns to the delivery vehicle 304. Second, sensor data may indicate the occurrence of one or more delivery events indicating a moment in time that a delivery took place at the delivery address. Third, sensor data may capture unique data describing the environment from the perspective of the user apparatus 20 and the position or location of the user apparatus 20.

In various example embodiments, the system apparatus 10 obtains (e.g., receives via network 2) at least a portion of the sensor data captured by the user apparatus 20. In an example embodiment, the sensor data captured by the user apparatus 20 is stored in a database 6, and the system apparatus 10 retrieves the sensor data from the database 6. In another example embodiment, the sensor data captured by the user apparatus 20 is transmitted by the user apparatus 20 such that the system apparatus 10 receives the captured sensor data. The system apparatus 10 may be configured to determine position estimates (e.g., GNSS-based position estimates, fusion position estimates) for the user apparatus 20 and provide the position estimates to the user apparatus 20. The system apparatus 10 may also determine the occurrence of one or more events indicating a moment in time that a delivery took place at the delivery address. In another example embodiment, the user apparatus 20, additionally or instead, determines the occurrence of delivery events from the sensor data.

Thus, the first timepoint 300A may indicate a moment in time when the user apparatus 20 begins capturing sensor data, and when the system apparatus 10 and/or the user apparatus 20 begin determining whether a delivery has occurred based on captured sensor data. In the illustrated example, a delivery event has not occurred at the first timepoint 300A, for example, and the delivery entity 302 is not positioned at the delivery address (e.g., room 312C) yet.

The delivery entity 302 may then navigate to an entry point of building 310 while remaining positioned outside of the building 310. The second timepoint 300B then may be a moment in time just prior to the delivery entity 302 entering the building 310. At the second timepoint 300B, the user apparatus 20 may continue to capture sensor data via one or more sensors 30. As previously discussed, captured sensor data may include audio data, inertial and/or movement data, GNSS data, radio data, and/or other data captured by sensors 30 of the user apparatus 20. The user apparatus 20 may continue to capture sensor data at a specific frequency (e.g., multiple times per second, once per second, once every 2 to 10 seconds, and/or the like). For example, the user apparatus 20 captures sensor data in 10 second intervals. In various example embodiments, each modality of sensor data (e.g., audio, inertial, GNSS-based, radio, and/or the like) is captured at different frequencies. For example, inertial and/or movement data may be captured at a higher frequency than radio data. For example, in an example embodiment, inertial and/or movement data is captured in approximately 0.01 second intervals, barometer data may be captured in approximately 0.1 second intervals, GNSS data may be captured in approximately 1 second intervals, and radio (e.g., Wi-Fi) data may be captured in approximately 3 second to 30 second intervals.

Due to the second timepoint 300B being a moment in time just prior to the delivery entity 302, and the user apparatus 20, entering the building 310, a GNSS-based position estimate obtained by the user apparatus 20 may serve as a reference GNSS-based position estimate. It will be understood that GNSS-based positioning may not be as reliable and/or accurate when the user apparatus 20 is positioned within the building 310, due to the user apparatus 20 receiving less GNSS signals or receiving GNSS signals at a lower intensity due to attenuation of the GNSS signals as they travel through the building 310. Therefore, when the user apparatus 20 receives lower intensity GNSS signals or less GNSS signals, the user apparatus 20 may refer to the GNSS-based position estimate obtained at the second timepoint 300B as a reference GNSS-based position estimate, or the last reliable GNSS-based position estimate. For example, fusion position estimates for the user apparatus 20 obtained while the user apparatus 20 is in the building 310 may be based on the reference GNSS-based position estimate determined at timepoint 300B (e.g., the last moment in time before the delivery entity 302 enters the building 310).

The occurrence of one or more delivery events, or events indicating that a delivery has taken place at the delivery address, may be determined based on the captured sensor data. As previously described, the system apparatus 10 may determine the occurrence of one or more delivery events based on the sensor data (e.g., received via network 2 from user apparatus 20). In an example embodiment, the user apparatus 20 may also be configured to determine the occurrence of one or more delivery events based on the sensor data. In the illustrated example, a delivery has not occurred at the second timepoint 300B, and the delivery entity 302 is not positioned at the delivery address (e.g., room 312C) yet.

The delivery entity 302 may then enter the building 310 through the entry point of the building 310. Due to being positioned within the building 310, the user apparatus 20 may not be able to obtain a relatively accurate GNSS-based position estimate due to the user apparatus 20 receiving GNSS signals at a lower signal intensity and/or observing a lack of GNSS signals, compared to timepoint 300A and/or 300B when the user apparatus 20 was located outside of the building 310. The third timepoint 300C then may be a moment in time subsequent to the delivery entity 302 entering the building 310 and when GNSS-based position estimates may be unreliable and/or relatively inaccurate. In various embodiments, at the third timepoint 300C, the user apparatus 20 may determine (e.g., begin determining and/or continue determining) fusion position estimates based on the reference GNSS-based position estimate obtained at the second timepoint 300B. In various embodiments, fusion position estimates generated at the third timepoint 300C may weigh inertial and/or movement data more heavily. In various embodiments, the user apparatus 20 primarily relies on GNSS-based position estimates prior to the third timepoint 300C, and begins relying on fusion position estimates at the third timepoint 300C.

The user apparatus 20 may continue to capture sensor data at the third timepoint 300C. As previously described, the captured sensor data includes captured radio data, captured by one or more radio sensors 38, that describes the radio environment at the position of the user apparatus 20. For example, radio data may include identifiers of observed network access points 308, respective signal strengths for each observed network access point 308, and various timing measurements for each observed network access point 308.

It will be understood that the radio data may differ at different moments in time and positions of the user apparatus 20. Here at the third timepoint 300C, the user apparatus 20 may observe three network access points 308A, 308B, 308C, whereas at the first timepoint 300A, the user apparatus 20 may only have observed one network access point 308A. Thus, radio data captured at the third timepoint 300C may comprise identifiers for network access points 308A-C, while radio data captured at the first timepoint 300A may comprise identifiers for only network access point 308A. For example, respective signal strengths observed from network access points 308A, 308B, and 308C may be higher at the position of the user apparatus 20 at the third timepoint 300C than respective signal strengths observed from network access points 308A, 308B, and 308C at the position of the user apparatus 20 at the first timepoint 300A.

The captured sensor data at the third timepoint 300C again may be used to determine whether a delivery has occurred at the delivery address (e.g., room 312C). As aforementioned, the system apparatus 10 and/or the user apparatus 20 may determine the occurrence of one or more events indicating that a delivery has occurred based on the captured sensor data. In the illustrated example, a delivery event has not occurred at the third timepoint 300C, for example, and the delivery entity 302 is not positioned at the delivery address (e.g., room 312C) yet.

Next, the delivery entity 302 may arrive at the delivery address (e.g., room 312C) and perform a delivery. The delivery entity 302 may perform one or more actions associated performing the delivery, which may be captured in captured sensor data and/or other data provided to the system apparatus 10 and/or the user apparatus 20 as one or more events indicating that the delivery took place at the delivery address (e.g., room 312C). The fourth timepoint 300D may correspond to a moment in time when the delivery entity 302 has performed the delivery and/or a moment in time when one or more events occur indicating that the delivery took place at the delivery address (e.g., room 312C).

As a first example action/event indicating a moment in time that a delivery took place at the delivery address, the delivery entity 302 may indicate through user input via a user interface 28 of the user apparatus 20 that the delivery entity 302 performed the delivery. In an example embodiment, the receiving entity 306 may indicate through user input via the user interface 28 (e.g., through a graphical user interface (GUI) of the courier application) of the user apparatus 20 that the delivery occurred. In an example embodiment, the indication by the delivery entity 302 that the delivery was performed is provided by the courier application operating on the user apparatus 20. For example, the delivery entity 302 may input the indication to the courier application, and the courier application may transmit the indication of the input such that the system apparatus 10 receives the indication of the input. Thus, the system apparatus 10 and/or the user apparatus 20 may determine that a delivery took place at the delivery address (e.g., room 312C) based on receiving an indication of user input indicating that the delivery occurred. The system apparatus 10 and/or the user apparatus 20 further determines the moment in time (e.g., the fourth timepoint 300D) when the delivery occurred at the delivery address (e.g., room 312C), such as when the indication of user input was received.

As a second example action/event indicating a moment in time that a delivery took place at the delivery address, a receiving entity 306 may provide a signature via a user interface 28 of the user apparatus 20 confirming that the receiving entity 306 has received the item. For example, a signature of the receiving entity 306 may be input in a courier application (e.g., via a GUI thereof) operating on the user apparatus 20. The courier application may then provide (e.g., transmit) the signature such that the system apparatus 10 receives the signature and/or receives an indication that a signature was inputted in the courier application. Thus, the system apparatus 10 and/or the user apparatus 20 may determine that a delivery took place at the delivery address (e.g., room 312C) based on receiving a signature of the receiving entity 306 and/or an indication that the receiving entity 306 has provided a signature. The system apparatus 10 and/or the user apparatus 20 further determines the moment in time (e.g., the fourth timepoint 300D) when the delivery occurred at the delivery address (e.g., room 312C), such as when the indication of a recipient signature was receiving.

As a third example action/event indicating a moment in time that a delivery took place at the delivery address, a delivery entity 302 may be stationary for a time period while performing the delivery. For example, the delivery entity 302 may be stationary to place a parcel on the doorstep, to knock on a door of the delivery address (e.g., room 312C), to converse with a receiving entity 306, to obtain a signature from the receiving entity 306, and/or the like. As such, the delivery entity 302 being stationary for a time period longer than a threshold amount of time may indicate that the delivery entity 302 performed a delivery at the delivery address (e.g., room 312C). The captured sensor data may indicate that the delivery entity 302 was stationary for a time period. For example, the captured sensor data includes inertial and/or movement data captured by one or more IMU and/or motion sensors 34, which may indicate that the user apparatus 20 had a substantially zero velocity and/or velocity below a threshold level for at least a threshold amount of time, for example. In another example, the one or more IMU and/or motion sensors 34 may indicate that the user apparatus 20 deaccelerated (e.g., to a substantially zero velocity) and, after a threshold amount of time, accelerated (e.g., e.g., to a substantially non-zero velocity). Thus, the system apparatus 10 and/or the user apparatus 20 may obtain the captured sensor data indicating that the user apparatus 20 was stationary for a time period, compare the stationary time period to a threshold amount of time, and determine that a delivery took place at the delivery address (e.g., room 312C) based on the comparison, in an example embodiment. In various example embodiments, the threshold amount of time is 5 seconds. In various example embodiments, the system apparatus 10 and/or the user apparatus 20 determine that a delivery took place when the stationary time period is between approximately 5 seconds and approximately 60 seconds. The system apparatus 10 and/or the user apparatus 20 may be further configured to determine the moment in time (e.g., the fourth timepoint 300D) when the delivery occurred at the delivery address (e.g., room 312C), such as when the user apparatus 20 was stationary for the time period.

As a fourth example action/event indicating a moment in time that a delivery took place at the delivery address, a delivery entity 302 may turn substantially 180 degrees. In an example embodiment, a turn of substantially 180 degrees is a change in orientation and/or heading in a range of 150 to 210 degrees. For example, the delivery entity 302 may change a heading by substantially 180 degrees after performing a delivery to leave the delivery address, exit the building 310, and return to the delivery vehicle 304. The change in heading or orientation by substantially 180 degrees may occur immediately after the delivery, after the receipt of a signature from the receiving entity 306, and/or the like, or may occur substantially close to the exact moment in time of the delivery. In the illustrated embodiment, for example, the delivery entity 302 may move from a first position at the third timepoint 300C to a second position at the fourth timepoint 300D (shown in solid line), perform at delivery at the delivery address (e.g., room 312C), and then turn substantially 180 degrees in order to move and return to third position at a fifth timepoint 300E (shown in dashed line). The substantially 180 degrees turn may be indicated in the captured sensor data. For example, the captured sensor data may include inertial and/or movement data captured by one or more IMU and/or motion sensors 34, which may indicate that the user apparatus 20 has changed a heading or orientation by substantially 180 degrees. The system apparatus 10 and/or the user apparatus 20 may obtain the captured sensor data indicating that a heading of the user apparatus 20 changed by substantially 180 degrees and determine that a delivery took place at the delivery address (e.g., room 312C). In an example embodiment, the system apparatus 10 and/or the user apparatus 20 may determine that a delivery took place based on receiving sensor data indicating that the heading of the user apparatus 20 changed by a degree between approximately 150 degrees and approximately 210 degrees. The system apparatus 10 and/or the user apparatus 20 further determines the moment in time (e.g., the fourth timepoint 300D) when the delivery occurred at the delivery address (e.g., room 312C), such as when the user apparatus 20 has changed heading or orientation by substantially 180 degrees.

As a fifth example action/event indicating a moment in time that a delivery took place at the delivery address, a delivery entity 302, after performing a delivery, may travel along and substantially retrace a trajectory previously traveled (e.g., from the entry point of the building 310 to the delivery address at room 312C). In the illustrated embodiment for example, the path travelled by the delivery entity 302 after making the delivery at the delivery address (e.g., room 312C) (shown in dashed lines) may be substantially similar to the path travelled by the delivery entity 302 to the delivery address (shown in solid lines). Retracing of a previous trajectory may be indicated in the captured sensor data, including inertial and/or movement data, which may be obtained by the system apparatus 10 and/or the user apparatus 20.

In various embodiments, the system apparatus 10 and/or the user apparatus 20 determines retracing of a previous trajectory based on position estimates (e.g., fusion position estimates) associated with different moments in time. For example, the system apparatus 10 and/or the user apparatus 20 determines whether a first fusion position estimate at time t is substantially close to (e.g., within a pre-determined distance and/or radius of) a previous fusion position estimate at time t−10 (e.g., 10 seconds prior to time t). The system apparatus 10 and/or the user apparatus 20 may then determine whether a second, and later, fusion position estimate at time t+5 (e.g., 5 seconds after time t) is substantially close to an earlier previous fusion position estimate at time t−15 (e.g., 15 seconds prior to time t). If the two pairs of fusion position estimates are substantially close, then the system apparatus 10 and/or the user apparatus 20 determine that the delivery entity 302 is retracing a previous trajectory. As shown in the illustrated embodiment, for example, a fusion position estimate at the third timepoint 300C is compared to a fusion position estimate at the fifth timepoint 300E, and a fusion position estimate at the second timepoint 300B is compared to a fusion position estimate at the sixth timepoint 300F. A retracing of the previous trajectory is then determined if both the fusion position estimates at the third timepoint 300C and fifth timepoint 300E are substantially close and the fusion position estimates at the second timepoint 300B and sixth timepoint 300F are substantially close, for example. In other example embodiments, other methods of determining retracing of a trajectory may be used. For example, machine learning methods may be used to determine a similarity between a first trajectory and a second trajectory. The system apparatus 10 and/or the user apparatus 20 further determines the moment in time (e.g., the fourth timepoint 300D) when the delivery entity 302 begins retracing a previous trajectory. For example, the system apparatus 10 and/or the user apparatus 20 may determine that the time t, in the aforementioned example, is the moment in time when the delivery entity 302 begins retracing a previous trajectory and the moment in time that the delivery took place at the delivery address.

As a sixth example action/event indicating a moment in time that a delivery took place at the delivery address, the delivery entity 302 may perform a delivery at the delivery address (e.g., room 312C), where the delivery address is at the furthermost point from the building entry point throughout a trajectory of the delivery entity 302 within the building. In the illustrated embodiment for example, the trajectory of the delivery entity 302 comprises first travelling from the entry point of the building 310 to the delivery address at room 312C (shown in solid line) and then returning to the entry point of the building 310 (shown in dotted line). Thus, in this example trajectory and in other various trajectories, the delivery address (e.g., room 312C) is the furthermost point from the entry point of the building 310. In various embodiments, the delivery address (e.g., room 312C) is also the furthermost point in a trajectory relative to the delivery vehicle 304 or the beginning of the trajectory.

Thus, the system apparatus 10 and/or the user apparatus 20 may determine, based on captured sensor data and fusion position estimates, the furthermost point (e.g., the delivery address at room 312C) from the entry point of building 310. In various embodiments, the trajectory of the delivery entity 302 within the building is described by multiple fusion position estimates for the user apparatus 20 at different moments in time. Therefore, the system apparatus 10 and/or the user apparatus 20 determines the furthermost point (e.g., room 312C) in the trajectory based on processing of fusion position estimates and/or sensor data. The system apparatus 10 and/or the user apparatus 20 further determines the moment in time when the delivery entity 302 was located at the furthermost point (e.g., room 312C) and when the delivery took place at the delivery address (e.g., room 312C).

As a seventh example action/event indicating a moment in time that a delivery took place at the delivery address, a machine-learned trained classification algorithm may determine and indicate that a delivery has occurred and/or the moment when a delivery occurred. In various embodiments, the classification algorithm may be trained on captured sensor data from other delivery moments from other delivery entities 302 and/or the same delivery entity 302. For example, the classification algorithm may be trained on example datasets including inertial and/or movement data captured by one or more IMU and/or motion sensors 34, radio data captured by one or more radio sensors 38, and/or audio data captured by one or more audio sensors 32. The example datasets including inertial, movement, radio, and/or audio data (e.g., a dialog between a delivery entity 302 and a receiving entity 306) may be obtained from one or more other user apparatuses 20, a database 6, other system apparatuses 10, and/or the like. The example datasets may include data labelling the exact delivery moments, and the classification algorithm may be trained in a supervised manner with respect to the labelled delivery moments in the example datasets. For example, U.S. patent application Ser. No. 17/301,304, filed Mar. 31, 2021, discloses an example classification engine trained to determine and/or estimate a context categorization (e.g., performing a delivery) for a mobile device based on processing, analyzing, and/or the like, an audio sample, the context of which is hereby incorporated by reference in its entirety. Thus, the system apparatus 10 and/or the user apparatus 20 may receive an indication or determination from a machine-learning trained classification algorithm, engine, and/or the like, that a delivery has occurred. The indication may comprise a timestamp or indication of a moment in time when the delivery occurred. In an example embodiment, the indication includes a location of the delivery. In another example embodiment, the system apparatus 10 and/or the user apparatus 20 determines a location of the delivery based on referencing fusion position estimates and a trajectory of the delivery entity 302 with the indicated timestamp.

As an eighth example action/event indicating a moment in time that a delivery took place at the delivery address, the delivery entity 302 may travel from a ground floor of the building 310 to another floor of the building 310 where the delivery address is located. As illustrated in FIG. 3B, the building 310 may be a multi-floored building comprising more than one floor 314, where each floor 314 may include suites, units, rooms, and/or the like, 312. Thus, after the third timepoint 330C when the delivery entity 302 enters the building 310, the delivery entity 302 may travel to a different floor 314 where the delivery entity may perform a delivery at the fourth timepoint 330D. For example, in the illustrated embodiment, the delivery entity 302 and the user apparatus 20 are positioned on the ground floor 314A at the third timepoint 330C, and then at the fourth timepoint 330D, the delivery entity 302 and the user apparatus 20 are positioned on the third floor 314C where the delivery address at room 312F is located.

As such, captured sensor data may indicate a change in elevation over time, such as between the third timepoint 330C and fourth timepoint 330D, and/or indicate an elevation substantially similar to an elevation of the delivery address (e.g., room 312C). For example, sensor data includes barometer data that may indicate the elevation and/or a change in elevation of the user apparatus. Thus, based on sensor data such as barometer data, the system apparatus 10 and/or the user apparatus 20 may determine that the user apparatus 20 is located on a floor 314 of the delivery address (e.g., floor 314C with room 312F) different from the ground floor 314A. In various embodiments, the system apparatus 10 and/or the user apparatus 20 first determines the floor 314 of the delivery address. For example, the system apparatus 10 and/or the user apparatus 20 may determine the floor 314 of the delivery address based on a positioning map, POI map, indoor venue map, and/or the like, or may determine based on encoding of the delivery address (e.g., Suite #4900 located on the 49^{th} floor). The system apparatus 10 and/or the user apparatus 20 then determines an elevation value corresponding to the floor 314 of the delivery address (e.g., floor 314C with room 312F) and compares the elevation value of the floor 314 of the delivery address to barometer data, an elevation value determined from the barometer data, and/or a change in elevation determined from the barometer data, such that the system apparatus 10 and/or the user apparatus 20 determines whether the user apparatus 20 is positioned on the floor 314 of the delivery address (e.g., floor 314C with room 312F), in an example embodiment. The system apparatus 10 and/or the user apparatus 20 further determines the moment in time (e.g., the fourth timepoint 330D) when the delivery entity 302 and the user apparatus 20 are located on the floor 314 of the delivery address (e.g., floor 314C with room 312F).

System apparatus 10 and/or user apparatus 20 may be configured to determine the occurrence of such delivery events in real-time, in various embodiments, or in non-real-time. For example, system apparatus 10 receives sensor data continuously as user apparatus 20 captures the sensor data, and in real-time, determines the occurrence of the user apparatus 20 changing heading by substantially 180 degrees. The system apparatus 10 may additionally or alternatively receive sensor data at a specific frequency and/or on an ad hoc basis. On the other hand, system apparatus 10 may access captured sensor data (e.g., from a database 6) and determine, based on processing captured sensor data for an entire delivery trajectory from a non-real-time perspective, the occurrence of the user apparatus 20 being located at the furthermost point in the trajectory from an entry point of the building 310, for example. In various embodiments, system apparatus 10 and/or user apparatus 20 are configured to determine the occurrence of certain delivery events in real-time and certain other delivery events in non-real-time.

In various example embodiments, the system apparatus 10 and/or the user apparatus 20 may determine the occurrence of only a subset of the aforementioned eight example actions/events. For example, the delivery address may be located within a building 310 with only one floor 314. Therefore, the system apparatus 10 and/or the user apparatus 20 does not determine whether the user apparatus 20 is positioned on a floor 314 of the delivery address that is not the ground floor, but may continue to monitor for the occurrence of each of the seven other example actions/events. As another example, the delivery entity 302 may be instructed to not request or obtain a recipient signature on the user apparatus 20 (e.g., due to a pandemic, epidemic, receiving entity 306 preference, courier service policy). As such, the system apparatus 10 and/or the user apparatus 20 does not determine whether an indication of a recipient signature has been received, thereby conserving computing and processing power. In various embodiments, various combinations of two or more action/events indicating a moment in time that a delivery took place at the delivery address may be used to determine the moment in time that the delivery took place at the delivery address.

As a further example, the delivery entity 302 may be tasked with performing more than one delivery within a building 310; that is, a building 310 may comprise more than one delivery address. For example, in the illustrated example of FIG. 3C, the building 310 comprises two delivery addresses, one for each of receiving entities 306A and 306B, respectively located at rooms 312C and 312F. In the illustrated example, the fourth timepoint 360D is a moment in time when a delivery entity 302 performs a first delivery at the first delivery address (e.g., room 312C), and the fifth timepoint 360E is a moment in time when the delivery entity 302 performs a second delivery at the second delivery address (e.g., room 312F). In such example scenarios, various embodiments may not determine whether certain delivery actions/events occur, such as whether the heading of the user apparatus 20 changes by substantially 180 degrees or whether the delivery entity 302 retraces a previous trajectory. For example, the heading of the user apparatus 20 does not change by substantially 180 degrees at the fourth timepoint 360D or at the fifth timepoint 360E. For example, the delivery entity 302 does not retrace a previous trajectory (shown in solid lines) after performing the deliveries. However, each of receiving entities 306A and 306B may provide recipient signatures, and therefore, the system apparatus 10 and/or the user apparatus 20 may determine the occurrence of both deliveries at delivery addresses at room 312C and room 312F. Thus, various embodiments of the present disclosure may monitor and determine the occurrence of a combination or set of certain delivery events based at least in part on the delivery address and/or the building 310. For example, system apparatus 10 and/or user apparatus 20 may not be configured to determine the occurrence of a change of heading of the user apparatus 20 by substantially 180 degrees when the delivery entity 302 is tasked with performing two deliveries to two delivery addresses within the same building 310. In an example embodiment, a change in orientation and/or heading of the user apparatus 20 and/or a partial re-tracing of a previous trajectory by the user apparatus 20 may be used in combination with one or more other actions/events to determine moments in time when deliveries have occurred at respective delivery addresses within a same building 310.

Each of the aforementioned example actions/events may indicate a moment in time when a delivery has occurred at the delivery address (e.g., room 312C). In various embodiments, the example actions/events may further indicate a position (e.g., a fusion position estimate) associated with the occurrence of the delivery and/or the delivery moment in time. It will be understood that the aforementioned example actions/events are not limiting, and other actions/events that may indicate that a delivery has taken place at the delivery address (e.g., room 312C) may be determined by the system apparatus 10 and/or the user apparatus 20. For example, captured sensor data comprises image data, and the delivery entity 302 may capture an image of a delivered parcel on a doorstep. System apparatus 10 and/or user apparatus 20 may then receive an indication from a machine learning image processing model that a delivery has occurred at the delivery address, based on the captured image, for example. In another example, an audio sample captured by an audio sensor 32 of the user apparatus 20 may be analyzed (e.g., using a natural language processing model) to identify when a delivery entity 302 uses words or phrases indicative of performing a delivery (e.g., “here's your package,” “delivery for,” “please sign here to accept delivery of,” and/or the like) to determine a moment in time when a delivery occurred at the delivery address.

Upon the determination of one or more events indicating a moment in time (e.g., the fourth timepoint 300D) that the delivery took place at the delivery address (e.g., room 312C), a position estimate for the user apparatus 20 substantially corresponding to the moment in time of the delivery may be obtained. For example, upon determining that one or more such events have occurred, the user apparatus 20 may obtain a fusion position estimate based on captured sensor data and the reference GNSS-based position estimate obtained at the second timepoint 300B. The fusion position estimate corresponds to the moment in time (e.g., the fourth timepoint 300D) when the delivery occurred, and may be considered as a delivery moment position estimate. In an example embodiment, the delivery moment position estimate may be determined based at least in part on a GNSS-based position estimate after the user apparatus 20 exits the building. In an example embodiment, the delivery moment position estimate may be determined based on a trajectory of the user apparatus 20 through the building based at least in part on the captured sensor data. In an example embodiment, the delivery moment position estimate is a radio-based position estimate generated based on one or more access points observed by the user apparatus 20 substantially at the moment in time the delivery occurred (e.g., while the user apparatus 20 was located at the delivery address).

In various embodiments, the system apparatus 10 determines, in real-time, the occurrence of one or more delivery events and transmit instructions to the user apparatus 20, such that the user apparatus 20 obtains a delivery moment position estimate. In other various embodiments, the system apparatus 10 determines, in non-real-time, the occurrence of one or more delivery events (e.g., the delivery entity 302 being positioned at a furthermost point from a reference point such as an entry point of the building 310 or the delivery vehicle 304) and transmits instructions to the user apparatus 20 such that the user apparatus 20 obtains (e.g., retrieves from memory 24) a delivery moment position estimate, where the delivery moment position estimate is a fusion position estimate associated with the moment in time indicated by the one or more delivery events. In an example embodiment, the user apparatus 20 determines, in real-time or in non-real-time, the occurrence of one or more delivery events and obtains (e.g., captures, retrieves from memory 24) a delivery moment position estimate.

In various embodiments, obtaining the delivery moment position estimate may be based on determining the occurrence of one event. However, in other example embodiments, obtaining the delivery moment position estimate may be based on determining the occurrence of multiple (e.g., two or more) events. For example, it may be preferred that obtaining the delivery moment position estimate is based on determining the occurrence of two or more events due to possible uncertainty associated with various events. In various embodiments, obtaining the delivery moment position estimate is based on determining the occurrence of multiple events within a pre-determined time window. For example, obtaining the delivery moment position estimate is based on determining the occurrence of two or more events within a 15 second time window.

In addition to and/or instead of obtaining the delivery moment position estimate, delivery moment data may be obtained upon the determination of the occurrence of one or more delivery events. Delivery moment data specifically refers to sensor data captured in the delivery moment, such as the moment in time (e.g., the fourth timepoint 300D) indicated by the one or more delivery events, or otherwise corresponding to the delivery moment. For example, the delivery moment data may be captured within a threshold amount of time (e.g., one second, five seconds, ten seconds, thirty seconds, and/or the like) of the moment in time identified as the moment the delivery occurred at the delivery address and/or while the user apparatus 20 has moved less than a threshold distance (e.g., one meter, five meters, ten meters, and/or the like) from the delivery address. In accordance with captured sensor data, delivery moment data is captured by one or more sensors 30 of the user apparatus 20 and may include audio data, inertial and/or movement data, GNSS data, radio data, and/or other data captured by sensors 30 of the user apparatus 20. In various embodiments, delivery moment data includes at least radio data. As previously described, radio data may describe the radio environment observed by the user apparatus 20 at a specific position, such as observed network access points 308, respective signal strengths from observed network access points 308, various timing measurements for observed network access points 308, and/or the like. As such, delivery moment data may include radio data, which may describe the radio environment observed by the user apparatus 20 at the delivery moment, which is a moment in time (e.g., fourth timepoint 300D) when the user apparatus 20 is positioned at the delivery address (e.g., room 312C). In various embodiments, delivery moment data may include image data, such as an image of room 312C.

Subsequent to obtaining at least one of the delivery moment position estimate for the user apparatus 20 or delivery moment data captured by one or more sensors 30 of the user apparatus 20, a positioning map may be updated, in various example embodiments. Updating a positioning map in various embodiments is based on the assumption that fusion position estimates and the delivery moment position estimate for the user apparatus 20 are more reliable and/or more accurate compared to the positioning map. Stated otherwise, the positioning map may be updated in embodiments where the reliability and accuracy of the positioning map can be improved with fusion position estimates and the delivery moment position estimate. For example, the positioning map may be lacking information corresponding to the delivery address; thus, the positioning map may be supplemented by at least the delivery moment position estimate and/or the delivery moment data. For example, in an example embodiment, the delivery moment data is associated with the delivery moment position estimate. In another example embodiment, the delivery moment data is associated with the delivery address. The delivery moment data associated with the delivery moment position estimate and/or the delivery address is then used to update the positioning map and/or one or more radio models thereof (e.g., coverage area and/or other radio models corresponding to access points 308 identified in radio data of the delivery moment data).

In various example embodiments, the positioning map may be stored in a database 6 and may comprise map data associating address information with positioning or location information. In an example embodiment, at least a portion of the positioning map may be stored in memory 14 of the system apparatus 10 and/or the memory 24 of the user apparatus 20. In various embodiments, the system apparatus 10 updates the positioning map, or at least a portion of the positioning map. Additionally or alternatively, the user apparatus 20 updates the positioning map, in an example embodiment.

The positioning map may be updated by associating the delivery address with the delivery moment data in map data of the positioning map (e.g., in database 6, memory 14, memory 24). For example, the delivery moment data is assigned to an area corresponding to the delivery address and/or an uncertainty associated with the delivery moment position estimate. As previously described, the delivery moment data may include radio data describing the radio environment at the delivery moment position estimate. Thus, the delivery moment data may be assigned to an area corresponding to the delivery address, due to the assumption that the delivery moment data describes an environment from the perspective of a position substantially close to an area associated with the delivery address. The delivery moment position estimate may be associated with an uncertainty. For example, the delivery moment position estimate may be a fusion position estimate, and there may be an uncertainty associated with the inertial and/or movement data used to generate the delivery moment position estimate. An IMU and/or motion sensor 34 capturing inertial and/or movement data may be associated with an error window, standard deviation, tolerance values, and/or the like, for the measurements and data provided. Map data used to generate the delivery moment position estimate likewise may be associated with an uncertainty. Therefore, the delivery moment data may be assigned to an area corresponding to an uncertainty associated with the delivery moment position estimate. For example, the delivery moment data is assigned to an area centered on the delivery moment position estimate with a radius corresponding to an uncertainty factor of the delivery moment position estimate. It may be appreciated that such an area corresponding to an uncertainty of the delivery moment position estimate may include an area corresponding to the delivery address.

The positioning map may also be updated by associating the delivery address with the delivery moment position estimate, based on the assumption that the delivery moment position estimate for the user apparatus 20 was obtained when the user apparatus 20 was positioned substantially near the delivery address. Thus, the positioning map may be updated to essentially indicate that the delivery address is located substantially near the delivery moment position estimate. As previously discussed, the system apparatus 10 and/or the user apparatus 20 updates the positioning map. In various embodiments, the system apparatus 10 updates the positioning map by associating with the delivery address with one or more delivery moment position estimates for one or more different user apparatuses 20. In other words, a location for the delivery address may be associated with multiple delivery moment position estimates, in a crowd-sourcing fashion. For example, the location for the delivery address in the positioning map is based on an average of the multiple delivery moment position estimates.

Additionally or alternatively to updating the positioning map, the delivery moment position estimate for the user apparatus 20 may be updated. In various embodiments, the positioning map is relatively complete, reliable, and accurate, and may contain data, such as location data, radio data, sensor data, previous delivery moment position estimates, and/or the like, associated with the delivery address (e.g., room 312C). For example, the positioning map may be, may comprise, may have access to, and/or the like, an address geolocation map comprising map data associating addresses to positions, locations, coordinates, and/or the like. In such an example, a position for the delivery address may be obtained from the positioning map and may be used to update the delivery moment position estimate for the user apparatus 20 and/or a fusion estimate position process used to generate the delivery moment position estimate. In various embodiments, the delivery address and/or the position for the delivery address obtained from the positioning map is provided to a positioning filter or a smoother algorithm as a measurement of uncertainty that substantially covers an area associated with the delivery address. For example, the delivery moment position estimate for the user apparatus 20 may differ from the position for the delivery address obtained from the positioning map, and the delivery moment position estimate for the user apparatus 20 is updated based on the position for the delivery address and the positioning filter. In various embodiments, the system apparatus 10 and/or the user apparatus 20 uses a positioning filter or smoother algorithm to update the delivery moment position estimate for the user apparatus 20 based on the position of the delivery address obtained from the positioning map.

In various embodiments, an area (e.g., a polygon, ellipse, circle) for the delivery address—in contrast to a specific position for the delivery address—may be obtained from the positioning map. For example, the delivery address may correspond to an area such as a room, suite of rooms, building, and/or the like, and the delivery may occur at one point within the area associated with the delivery address. In such embodiments, a measurement of uncertainty based on the area may be provided to a positioning filter or smoother algorithm. For example, the measurement of uncertainty may be an ellipse or polygon of minimum size needed to encompass the area for the delivery address (e.g., the room, suite of rooms, building, etc. associated with the delivery address) and/or the delivery moment position estimate for the user apparatus 20. As such, the system apparatus 10 may update the delivery moment position estimate for the user apparatus 20 by providing an area for the delivery address to a positioning filter or smoother algorithm as a measurement of uncertainty, indicating that the user apparatus 20 at the delivery moment may be positioned or located somewhere within the area of uncertainty (e.g., within the room, suite of rooms, building, etc. associated with the delivery address).

In various embodiments, the positioning map may be, may comprise, may have access to, and/or the like, a POI map or an indoor venue map. A POI map or an indoor venue map may comprise map data associating POIs, such as points of interest within a venue, to positions or locations. For example, a POI map or an indoor venue map may associate a business name or a service provider with a position and/or an area. Thus, the receiving entity 306 and the delivery address may be associated with a POI, and the positioning map may provide a position or area associated with the delivery address based on the associated POI. As such, the system apparatus 10 may update the delivery moment position estimate for the user apparatus 20 based on a position or area associated with the delivery address obtained from the positioning map.

The positioning map may be updated subsequent to and in association with updating the delivery moment position estimate. For example, the delivery moment position estimate is first updated to provide a more accurate position to associate (e.g., georeference) with the delivery moment data (e.g., radio data captured at the delivery moment). Then, the positioning map may be updated by assigning the delivery moment data with an area associated with the updated delivery moment position estimate.

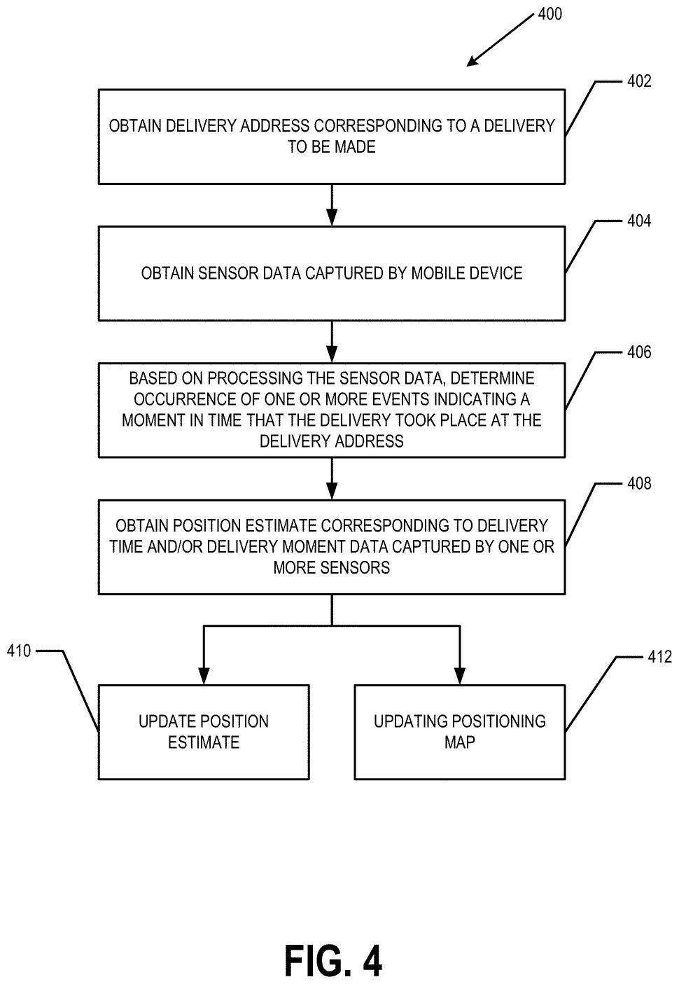

It will be understood that the various timepoints (e.g., 300A-D, 330A-D, 360A-E), as described herein and illustrated in FIGS. 3A-C, are not limiting and are described and illustrated purely for demonstrative purposes. Specifically, embodiments of the present disclosure may not specifically determine moments in time corresponding to various timepoints and may not specifically perform actions directly based on moments in time corresponding to various timepoints. Rather, various embodiments of the present disclosure may generally perform operations of process 400, as provided by FIG. 4. Various embodiments may perform operations of process 400 at moments in time unrelated to the various demonstrative timepoints illustrated in FIGS. 3A-C.

In various embodiments, process 400 comprises operation 402. For example, process 400 may begin at operation 402, which comprises obtaining a delivery address (e.g., room 312C, room 312F). The delivery address corresponds to a delivery to be made by a delivery entity 302. The delivery entity 302 is associated with a mobile device (e.g., user apparatus 20). In various embodiments, the system apparatus 10 obtains (e.g., receives) the delivery address. In various embodiments, the user apparatus 20 obtains the delivery address from a courier application operating on the user apparatus 20. In various embodiments, the system apparatus 10 and/or the user apparatus 20 comprises means, such as processors 12, 22, memory 14, 24, communication interface 16, 26, user interface 18, 28, and/or the like, for obtaining a delivery address corresponding to a delivery to be made by the delivery entity associated with the user apparatus 20. For example, the system apparatus 10 receives the delivery address via communication interface 16 from the user apparatus 20, the database 6, and/or the like. For example, the user apparatus 20 obtains the delivery address via user input through user interface 28.

In various embodiments, obtaining a delivery address may comprise processing the delivery address. For example, the system apparatus 10 and/or the user apparatus 20 may process the delivery address and identify a building 310 within which the delivery address is located. For example, the system apparatus 10 and/or the user apparatus 20 uses a positioning map (e.g., an address geolocation map, a POI map, an indoor venue map) to identify a building 310 within which the delivery address is located. The system apparatus 10 and/or the user apparatus 20 may further process the delivery address, for example, to determine a floor 314 of the delivery address.

In an example embodiment, process 400 further comprises operation 404. Operation 404 comprises obtaining sensor data captured by the mobile device (e.g., user apparatus 20) associated with the delivery entity 302. The sensor data may be captured by one or more sensors 30 of the mobile device or user apparatus 20. In various embodiments, the system apparatus 10 and/or user apparatus 20 comprise means, such as processor 12, 22, memory 14, 24, communication interface 16, 26, user interface 18, 28, and/or the like, for obtaining sensor data captured by one or more sensors 30. For example, the system apparatus 10 receives sensor data via communication interface 16 from the user apparatus 20, the database 6, and/or the like. For example, the user apparatus 20 captures the sensor data via one or more sensors 30. For example, the user apparatus 20 retrieves the sensor data from memory 24.

In various embodiments, the sensor data comprises audio data, inertial and/or movement data, GNSS data, radio data, and/or other data captured by sensors 30 of the user apparatus 20. The sensor data may indicate the occurrence of one or more events indicating a moment in time that a delivery took place at the delivery address. The sensor data (e.g., the inertial and/or movement data, GNSS data) may also be used to generate position estimates for the user apparatus 20, such as GNSS-based position estimates and fusion position estimates. The sensor data (e.g., radio data) may be further used to describe a captured environment at the position of the user apparatus 20. For example, radio data includes identifiers, signal strengths, pathloss estimates, timing measurements, and/or the like, for observed network access points 308, which may be unique and relative for different positions of the user apparatus 20. Sensor data may be repeatedly, continuously and/or periodically obtained over a period of time, in various embodiments, and portions of sensor data are encoded with timestamps or otherwise associated with moments in time when such portions were captured.

In various embodiments, process 400 further comprises operation 406. Operation 406 comprises determining the occurrence of one or more events indicating a moment in time that the delivery took place at the delivery address. Determining the occurrence of one or more delivery events is based at least in part on processing the sensor data captured by the mobile device (e.g., user apparatus 20). In various embodiments, the system apparatus 10 and/or the user apparatus 20 comprise means, such as processor 12, 22, memory 14, 24, communication interface 16, 26, user interface 18, 28, and/or the like, for determining the occurrence of one or more delivery events, or events indicating a moment in time that the delivery took place at the delivery address. For example, the system apparatus 10 and/or the user apparatus 20 comprise processor 12, 22 for performing functions or operations for processing the sensor data and determining whether an action/event indicating a moment in time that a delivery at a respective delivery address has occurred. In various embodiments, the system apparatus 10 and/or the user apparatus 20 periodically (e.g., at a specific frequency) determine whether one or more actions/events indicating moments in time that one or more deliveries at respective delivery addresses have occurred. For example, sensor data may be obtained (e.g., received, retrieved, captured) at a first frequency, and the system apparatus 10 and/or the user apparatus 20 process the sensor data at a second frequency, which may be equal to or less than the first frequency.

Examples of such actions/events indicating a moment in time that a delivery at a respective delivery address has occurred (also referred to herein as delivery events) have been discussed herein. As a first example, the system apparatus 10 and/or the user apparatus 20 receives an indication of user input via the user apparatus 20 that the delivery occurred. As a second example, the system apparatus 10 and/or the user apparatus 20 receives an indication of a recipient signature via the user apparatus 20. As a third example, the system apparatus 10 and/or the user apparatus 20 determines, based on the sensor data, that the user apparatus 20 was stationary for at least a threshold amount of time. As a fourth example, the system apparatus 10 and/or the user apparatus 20 determines, based on the sensor data, that a heading of the user apparatus 20 changed by substantially 180 degrees (e.g., approximately 150 degrees to approximately 210 degrees). As a fifth example, the system apparatus 10 and/or the user apparatus 20 determines, based on the sensor data, retracing of a previous trajectory, such as a trajectory from a building 310 entry point to a delivery point by the user apparatus 20. As a sixth example, the system apparatus 10 and/or the user apparatus 20 identifies a furthermost point from a building 310 entry point for a trajectory of the user apparatus 20 within the building 310. As a seventh example, the system apparatus 10 and/or the user apparatus 20 determine the occurrence of a delivery at the delivery address by a machine-learning trained classification algorithm. As an eighth example, the system apparatus 10 and/or the user apparatus 20 determines, based on barometer data, that the user apparatus 20 is located on a floor 314 of the delivery address, which is a floor 314 of the building 310 that does not include the building 310 entry point (e.g., not the ground floor). In various embodiments, the system apparatus 10 and/or the user apparatus 20 determines the occurrence of a combination or set of two or more delivery events based at least in part on the delivery address.

In various embodiments, process 400 further comprises operation 408. Operation 408 comprises obtaining at least one of (a) a position estimate for the user apparatus 20 substantially corresponding to the moment the delivery occurred, or (b) delivery moment data captured by one or more sensors of the mobile device substantially at the moment the delivery took place. In various embodiments, the position estimate for the user apparatus 20 substantially corresponding to the delivery moment is based on sensor data captured by the user apparatus 20. For example, the position estimate may be a GNSS-based position estimate. For example, the position estimate may be a fusion position estimate based on inertial, movement, and/or radio data combined with a GNSS-based position estimate. In various embodiments, the system apparatus 10 and/or the user apparatus 20 comprise means, such as processor 12, 22, memory 14, 24, communication interface 16, 26, user interface 18, 28, and/or the like, for obtaining at least one of (a) a position estimate for the user apparatus at the delivery moment, or (b) delivery moment data captured by one or more sensors at the delivery moment, or delivery moment sensor data. For example, the system apparatus 10 receives the delivery moment position estimate and/or the delivery moment sensor data via communication interface 16 from user apparatus 20, database 6, and/or the like. For example, the user apparatus 20 captures (e.g., in near real-time) a delivery moment position estimate and/or delivery moment sensor data. For example, the user apparatus 20 retrieves (e.g., from memory 14, from database 6) a delivery moment position estimate and/or delivery moment sensor data.

As shown in FIG. 4, process 400 further comprises operation 410. Operation 410 comprises updating a positioning map. Updating the position map is based at least in part on the delivery address and the at least one of (a) a delivery moment position estimate, or (b) delivery moment sensor data. In various embodiments, system apparatus 10 and/or user apparatus 20 comprise means, such as processor 12, 22, memory 14, 24, communication interface 16, 26, user interface 18, 28, and/or the like, for updating the positioning map based at least in part on the delivery address and the at least one of (a) a delivery moment position estimate, or (b) delivery moment sensor data. For example, the system apparatus 10 may communicate with a positioning map manager, engine, database 6, and/or the like, via communication interface 16 with updated information. For example, the system apparatus 10 and/or the user apparatus 20 stores at least a portion of the positioning map in memory 14, 24 in addition to executable code instructions, that when executed by processor 12, 22, update the positioning map. In various embodiments, updating the positioning map comprises associating the delivery moment data with the delivery address in map data of the positioning map. In various embodiments, delivery moment data may be assigned to an area corresponding to at least one of the delivery address or an uncertainty associated with the position estimate. In various embodiments, updating the positioning map comprises associating the delivery moment position estimate with the delivery address.

In various embodiments, process 400 further comprises operation 412. As shown in FIG. 4, operation 412 may be performed additionally or alternatively to operation 410, in an example embodiment. Operation 412 comprises updating the delivery moment position estimate for the user apparatus 20. In various embodiments, both the positioning map and the delivery moment position estimate are updated. In various other embodiments, the delivery moment position estimate is updated, and the positioning map is not updated. In various embodiments, system apparatus 10 and/or user apparatus comprise means, such as processor 12, 22, memory 14, 24, communication interface 16, 26, user interface 18, 28 and/or the like, for updating the delivery moment position estimate for the user apparatus 20. For example, system apparatus 10 transmits updated information via communication interface 16 such that the delivery moment position estimate, stored in memory 24 of user apparatus 20 or database 6, is updated. For example, user apparatus 20 performs functions or operations via processor 12 for updating the delivery moment position estimate. In various embodiments, operation 412 may be performed prior to operation 410. In various embodiments, updating the delivery moment position estimate comprises providing the delivery address to a positioning filter or smoother algorithm as a measurement associated with an uncertainty that substantially covers an area associated with the delivery address.

### IV. TECHNICAL ADVANTAGES

Various embodiments of the present disclosure provide significant technical advantages in the field. As described herein, embodiments of the present disclosure are directed to updating and improving positioning maps and position estimates based on the detection of delivery events. By updating and improving positioning maps and position estimates, various embodiments provide technical solutions to technical problems, such as indoor positioning and navigation. For example, technical problems exist with current positioning methods being unreliable or less accurate when navigating in an indoor environment due to factors such as GNSS and/or cellular signal attenuation. Furthermore, heavily relying on inertial and/or movement data may lead to sensor drift over time, because position estimates based on inertial and/or movement data are determined relative to previous position estimates. Thus, various embodiments may improve positioning maps and position estimates based further on radio data that describes the radio environment at various locations. As previously described, the radio environment (e.g., observed radio devices and network access points, signal strengths, timing measurements) vary and are dependent on a receiver's (e.g., user apparatus 20) location. Furthermore, radio devices and network access points may be existing infrastructure within buildings 310 of delivery addresses, and therefore may be more accurate for positioning compared to GNSS and cellular signals. As such, various example embodiments provide radio data to positioning maps as additional information to assist in positioning and further updating position estimates. In an example embodiment, a positioning map is updated with radio data describing the radio environment at a delivery address, and a user apparatus 20 may obtain a position estimate (e.g., an updated position estimate) based on the radio data and the delivery address.

Various embodiments further provide technical advantages by being configured to update positioning maps and/or position estimates with a large amount of data. For example, a system apparatus 10 may update a positioning map based on data (e.g., position estimate, sensor data) obtained from multiple user apparatuses 20. It may be appreciated that for a given delivery address, multiple delivery moment position estimates and delivery moment data may be obtained over the course of a time period, thereby eliminating noise and error to some degree when updating a location for the given delivery address in the positioning map. Likewise, a positioning map may be generated and maintained using data obtained in a crowd-sourcing manner, leading to more accurate position estimates when using the positioning map. Thus, by enabling the system apparatus 10 to update a positioning map and position estimates for multiple user apparatuses 20 based on data obtained from multiple user apparatuses 20, convergence on location truths may be quickly achieved. Furthermore, obtaining data from delivery entities 302 is particularly efficient due to a delivery entity 302 travelling to many different delivery addresses and each delivery address being visited by many different delivery entities 302.

Furthermore, embodiments of the present disclosure may be at least partially implemented and/or performed by a cloud-based computing system. For example, the system apparatus 10 may be a cloud-based computing system configured to communicate with multiple user apparatuses 20, thereby enabling a large crowd-sourcing framework. Embodiments of the present disclosure implemented by cloud-based computing systems provide technical advantages by conserving processing and computing power of user apparatuses 20, as the cloud-based computing systems (e.g., system apparatus 10) may handle a large amount of the processing and determination of position estimates and updated position estimates. As previously described, processing and computing power may be further conserved by monitoring a pre-determined or selected set of delivery events. Various scenarios may render certain delivery events impossible; thus, the system apparatus 10 may monitor and determine the occurrence of only certain events that indicate a moment in time that the delivery took place at the delivery address. Therefore, the system apparatus 10 may efficiently update a positioning map and/or position estimates.

### V. EXAMPLE APPARATUS

The system apparatus 10 and/or the user apparatus 20 of an example embodiment may be embodied by or associated with a variety of computing devices including, for example, a navigation system including a GNSS system, a cellular telephone, a mobile phone, a personal digital assistant (PDA), a watch, a camera, a computer, an Internet of things (IoT) item, and/or other device that can observe the radio environment (e.g., the cellular radio environment) in the vicinity of the computing device and/or that can store at least a portion of a positioning map. Additionally or alternatively, the system apparatus 10 and/or the user apparatus 20 may be embodied in other types of computing devices, such as a server, a personal computer, a computer workstation, a laptop computer, a plurality of networked computing devices or the like, that are configured to: obtain a delivery address corresponding to a delivery to be made by an entity associated with the user apparatus 20; obtaining sensor data captured by the user apparatus 20; based at least in part on processing the sensor data captured by the user apparatus 20, determining occurrence of one or more events indicating a moment in time that the delivery took place at the delivery address; obtaining at least one of (a) a position estimate for the user apparatus 20 substantially corresponding to the moment the delivery occurred, or (b) delivery moment data captured by one or more sensors of the user apparatus 20 substantially at the moment the delivery took place; and based at least in part on the delivery address and the at least one of (a) the position estimate or (b) the delivery moment data, updating at least one of (a) a positioning map, or (b) the position estimate for the user apparatus 20; and/or the like. For example, the user apparatus 20 is a mobile device. In an example embodiment, a user apparatus 20 is a smartphone, tablet, laptop, vehicle navigation system, and/or other mobile computing device, and a system apparatus 10 is a server that may be part of a Cloud-based processing system.

In some embodiments, the processor 12, 22 (and/or co-processors or any other processing circuitry assisting or otherwise associated with the processor) may be in communication with the memory device 14, 24 via a bus for passing information among components of the apparatus. The processor 12, 22 may communicate with other components of system apparatus 10 and/or user apparatus 20, respectively, via a bus. For example, the processor 22 communicates with one or more sensors 30 to obtain sensor data. The memory device 14, 24 may be non-transitory and may include, for example, one or more volatile and/or non-volatile memories. In other words, for example, the memory device 14, 24 may be an electronic storage device (e.g., a non-transitory computer readable storage medium) comprising gates configured to store data (e.g., bits) that may be retrievable by a machine (e.g., a computing device like the processor). The memory device 14, 24 may be configured to store information, data, content, applications, instructions, or the like for enabling the apparatus to carry out various functions in accordance with an example embodiment of the present invention. For example, the memory device 14, 24 could be configured to buffer input data for processing by the processor. For example, the memory device 14, 24 could be configured to store sensor data, position estimates, and/or positioning maps for processing by the processor. Additionally or alternatively, the memory device 14, 24 could be configured to store instructions for execution by the processor.

As described above, the system apparatus 10 and/or user apparatus 20 may be embodied by a computing entity and/or device. However, in some embodiments, the system apparatus 10 and/or user apparatus 20 may be embodied as a chip or chip set. In other words, the system apparatus 10 and/or user apparatus 20 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The system apparatus 10 and/or user apparatus 20 may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22 may be embodied in a number of different ways. For example, the processor 12, 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22 may include one or more processing cores configured to perform independently. A multi-core processor may enable multiprocessing within a single physical package. Additionally or alternatively, the processor 12, 22 may include one or more processors configured in tandem via the bus to enable independent execution of instructions, pipelining and/or multithreading.

In an example embodiment, the processor 12, 22 may be configured to execute instructions stored in the memory device 14, 24 or otherwise accessible to the processor. Alternatively or additionally, the processor 12, 22 may be configured to execute hard coded functionality. As such, whether configured by hardware or software methods, or by a combination thereof, the processor 12, 22 may represent an entity (e.g., physically embodied in circuitry) capable of performing operations according to an embodiment of the present invention while configured accordingly. Thus, for example, when the processor 12, 22 is embodied as an ASIC, FPGA or the like, the processor 12, 22 may be specifically configured hardware for conducting the operations described herein. Alternatively, as another example, when the processor 12, 22 is embodied as an executor of software instructions, the instructions may specifically configure the processor 12, 22 to perform the algorithms and/or operations described herein when the instructions are executed. However, in some cases, the processor 12, 22 may be a processor of a specific device (e.g., a pass-through display or a mobile terminal) configured to employ an embodiment of the present invention by further configuration of the processor by instructions for performing the algorithms and/or operations described herein. The processor 12, 22 may include, among other things, a clock, an arithmetic logic unit (ALU) and logic gates configured to support operation of the processor.

In some embodiments, the user apparatus 20 may optionally include a user interface 28 that may, in turn, be in communication with the processor 22 to provide output to the user, such as an indication that a positioning map and/or a position estimate has been updated, one or more navigable routes to a destination location and/or from an origin location, display of location dependent and/or triggered information, and/or the like, and, in some embodiments, to receive an indication of a user input. As such, the user interface 28 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 22 (e.g., memory device 24 and/or the like). In some example embodiments, the system apparatus 10 may also optionally include a user interface 18.

The system apparatus 10 and/or user apparatus 20 may optionally include a communication interface 16, 26. The communication interface 16, 26 may be any means such as a device or circuitry embodied in either hardware or a combination of hardware and software that is configured to receive and/or transmit data from/to a network and/or any other device or module in communication with the system apparatus 10 and/or the user apparatus 20. For example, communication interface 16 included in system apparatus 10 comprises means configured to receive and/or transmit data from/to a database 6 (e.g., a positioning map database). For example, a communication interface 16 included in system apparatus 10 is configured to receive sensor data and position estimates and provide (e.g., transmit) at least an updated position estimate. For example, a communication interface 26 included in user apparatus 20 is configured to provide (e.g., transmit) sensor data and position estimates and receive at least updated position estimates. In this regard, the communication interface 16, 26 may include, for example, an antenna (or multiple antennas) and supporting hardware and/or software for enabling communications with a wireless communication network (e.g., network 2). Additionally or alternatively, the communication interface 16, 26 may include the circuitry for interacting with the antenna(s) to cause transmission of signals via the antenna(s) or to handle receipt of signals received via the antenna(s). In some environments, the communication interface 16, 26 may alternatively or also support wired communication. As such, for example, the communication interface 16, 26 may include a communication modem and/or other hardware/software for supporting communication via cable, digital subscriber line (DSL), universal serial bus (USB) or other mechanisms.

In various embodiments, a system apparatus 10 and/or user apparatus 20 may comprise a component (e.g., memory 14, 24, and/or another component) that stores a digital map (e.g., in the form of a geographic database) comprising a first plurality of data records, each of the first plurality of data records representing a corresponding TME, wherein at least some of said first plurality of data records map information/data indicating current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location) to a point on a map, a lane of a lane network, and/or link, one or more localization features and a corresponding location of each localization feature, and/or the like. For example, the geographic database may comprise a positioning map comprising instances of neighbor-cell information that are each comprising, associated with, and/or indexed by a respective globally unique identifier. For example, a geographic database may include road segment, segment, link, lane segment, or traversable map element (TME) data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In example embodiments, the system apparatus 10 and/or user apparatus 20 may be configured to obtain, modify, update, and/or the like one or more data records of the geographic database. For example, the system apparatus 10 and/or the user apparatus 20 may obtain, modify, update, generate, and/or the like map information/data corresponding to TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME), a localization layer (e.g., comprising localization features) and/or the corresponding data records, and/or the like, based at least in part on sensor data, position estimates, and an indication of the occurrence of one or more delivery events.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. Data about the respective locations of the POIs may be generated based at least in part on trustworthy GNSS-based location estimates. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. For example, field personnel traveling by vehicle may record data such as GNSS-based location estimates. Also, remote sensing, such as aerial or satellite photography, can be used. In various embodiments, the geographic database is maintained (e.g., generated, enhanced, and/or the like) based on data collected by delivery entities 302 performing deliveries at various delivery addresses.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, a system apparatus 10 and/or user apparatus 20 in accordance with an example embodiment may generate the databases (e.g., a positioning map) comprising instances of neighbor-cell information that are each comprising, associated with, and/or indexed by a respective globally unique identifier and/or use the databases (e.g., the positioning map) to perform one or more positioning and/or navigation-related functions.

### VI. APPARATUS, METHODS, AND COMPUTER PROGRAM PRODUCTS

As described above, FIG. 4 illustrates a flowchart of a system apparatus 10 and/or user apparatus 20, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24 of an apparatus employing an embodiment of the present invention and executed by the processor 12, 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by at least one processor, a delivery address corresponding to a delivery to be made by an entity associated with a mobile device;
obtaining, by the at least one processor, sensor data captured by the mobile device;
based at least in part on processing the sensor data captured by the mobile device, determining, by the at least one processor, occurrence of one or more events indicating a moment in time that the delivery took place at the delivery address;
obtaining, by the at least one processor, at least one of (a) a position estimate for the mobile device substantially corresponding to the moment the delivery occurred, or (b) delivery moment data captured by one or more sensors of the mobile device substantially at the moment the delivery took place; and
based at least in part on the delivery address and the at least one of (a) the position estimate or (b) the delivery moment data, updating, by the at least one processor, at least one of a positioning map or the position estimate for the mobile device.

2. The method of claim 1, wherein updating the positioning map comprises associating the delivery moment data with the delivery address in map data of the positioning map.

3. The method of claim 2, wherein associating the delivery moment data with the delivery address comprises assigning the delivery moment data with an area corresponding to at least one of (a) the delivery address, or (b) an uncertainty associated with the position estimate.

4. The method of claim 2, wherein the delivery moment data comprises radio data identifying at least one radio device observed by the mobile device substantially at the moment the delivery took place.

5. The method of claim 1, wherein updating the positioning map comprises associating the position estimate with the delivery address, wherein the position estimate is determined based at least in part on the sensor data captured by the mobile device.

6. The method of claim 1, wherein updating the position estimate comprises providing the delivery address to a positioning filter or smoother algorithm as a measurement associated with an uncertainty that substantially covers an area associated with the delivery address.

7. The method of claim 1, wherein the one or more events comprise at least one of:
(i) receipt of an indication of user input received via a user interface of the mobile device, the user input indicating that the delivery occurred,
(ii) receipt of an indication of a recipient signature via the user interface of the mobile device,
(iii) based on the sensor data, a determination that the mobile device was stationary for at least a threshold amount of time,
(iv) based on the sensor data, a determination that a heading of the mobile device changed by substantially 180 degrees,
(v) based on the sensor data, a determination of a retracing of a trajectory from a building entry point to a delivery point by the mobile device,
(vi) identification of a furthermost point from a building entry point for a trajectory of the mobile device in a building corresponding to the building entry point,
(vii) determination by a machine-learning trained classification algorithm that the delivery occurred, or
(viii) determination that the mobile device is located on a floor of the delivery address based at least in part on barometer data captured by the mobile device, the floor being a level of a building associated with the delivery address that does not include the building entry point.

8. The method of claim 7, wherein the indication of the user input or the indication of the recipient signature is provided by a courier application operating on the mobile device.

9. The method of claim 1, wherein the sensor data comprises at least one of (a) movement data captured by the one or more motion sensors of the mobile device, (b) radio data captured by one or more radio sensors of the mobile device, or (c) barometer data captured by a barometer of the mobile device.

10. The method of claim 1, wherein the delivery address is obtained from a courier application operating on the mobile device.

11. The method of claim 1, wherein the position estimate is determined based at least in part on a global navigation satellite system (GNSS) based position estimate of the mobile device prior to the mobile device entering a building associated with the delivery address via a building entry point.

12. The method of claim 11, wherein the position estimate is further determined based at least in part on (a) a GNSS-based position of the mobile device after the mobile device exits the building, or (b) a trajectory of the mobile device through the building determined based at least in part on the sensor data.

13. An apparatus comprising at least one processor and at least one non-transitory memory including computer program code, the at least one memory and the computer program code configured to, with the at least one processor, cause an apparatus to at least:
obtain a delivery address corresponding to a delivery to be made by an entity associated with a mobile device;
obtain sensor data captured by the mobile device;
based at least in part on processing the sensor data captured by the mobile device, determine occurrence of one or more events indicating a moment in time that the delivery took place at the delivery address;
obtain at least one of (a) a position estimate for the mobile device substantially corresponding to the moment the delivery occurred, or (b) delivery moment data captured by one or more sensors of the mobile device substantially at the moment the delivery took place; and
based at least in part on the delivery address and the at least one of (a) the position estimate or (b) the delivery moment data, update at least one of a positioning map, or the position estimate for the mobile device.

14. The apparatus of claim 13, wherein updating the positioning map comprises associating the delivery moment data with the delivery address in map data of the positioning map.

15. The apparatus of claim 13, wherein updating the position estimate comprises providing the delivery address to a positioning filter or smoother algorithm as a measurement associated with an uncertainty that substantially covers an area associated with the delivery address.

16. The apparatus of claim 13, wherein the one or more events comprise at least one of
(i) receipt of an indication of user input received via a user interface of the mobile device, the user input indicating that the delivery occurred,
(ii) receipt of an indication of a recipient signature via the user interface of the mobile device,
(iii) based on the sensor data, a determination that the mobile device was stationary for at least a threshold amount of time,
(iv) based on the sensor data, a determination that a heading of the mobile device changed by substantially 180 degrees,
(v) based on the sensor data, a determination of a retracing of a trajectory from a building entry point to a delivery point by the mobile device,
(vi) identification of a furthermost point from a building entry point for a trajectory of the mobile device in a building corresponding to the building entry point,
(vii) determination by a machine-learning trained classification algorithm that the delivery occurred, or
(viii) determination that the mobile device is located on a floor of the delivery address based at least in part on barometer data captured by the mobile device, the floor being a level of a building associated with the delivery address that does not include the building entry point.

17. The apparatus of claim 16, wherein the indication of the user input or the indication of the recipient signature is provided by a courier application operating on the mobile device.

18. The apparatus of claim 13, wherein the sensor data comprises at least one of (a) movement data captured by the one or more motion sensors of the mobile device, (b) radio data captured by one or more radio sensors of the mobile device, or (c) barometer data captured by a barometer of the mobile device.

19. The apparatus of claim 13, wherein the delivery address is obtained from a courier application operating on the mobile device.

20. A computer program product comprising at least one non-transitory computer-readable storage medium having computer-executable program code instructions stored therein, the computer-executable program code instructions comprising program code instructions configured to, when executed at least one processor, cause the at least one processor to:
obtain a delivery address corresponding to a delivery to be made by an entity associated with a mobile device;
obtain sensor data captured by the mobile device;
based at least in part on processing the sensor data captured by the mobile device, determine occurrence of one or more events indicating a moment in time that the delivery took place at the delivery address;
obtain at least one of (a) a position estimate for the mobile device substantially corresponding to the moment the delivery occurred, or (b) delivery moment data captured by one or more sensors of the mobile device substantially at the moment the delivery took place; and
based at least in part on the delivery address and the at least one of (a) the position estimate or (b) the delivery moment data, update at least one of a positioning map, or the position estimate for the mobile device.
